(19) United States
(12) Patent Application Publication
(10) Pub. No.: US 2006/0099843 A1
(43) Pub. Date: May 11, 2006

(54) Dielectric fittings

(76) Inventors: Todd C. Fullner, Haslet, TX (US); Geoffrey Zhang, Van Nuys, CA (US); Joseph Marban, Newbury Park, CA (US)

Correspondence Address: John A. Molnar, Jr.;PARKER-HANNIFIN CORPORATION, 6035 Parkland Boulevard, Cleveland, OH, 44124-4141, US

(21) Appl. No.: 11/258,710

(22) Filed: Oct. 26, 2005

Related U.S. Application Data
(60) Provisional application No. 60/624,109, filed on Nov. 1, 2004.
(60) Provisional application No. 60/672,818, filed on Apr. 19, 2005.

(51) Int. Cl. H01R 13/52

(52) U.S. Cl. 439/275

(57) ABSTRACT

A dielectric tubular fitting for dissipating electrical energy, while providing fluid flow therethrough, the fitting including coaxial first and second generally tubular light metal housings, with a first, generally cylindrical, spacer of a Peek material composition being sealingly interposed therebetween and a first generally disc-shaped first ESD (Electrostatic Discharge) spacer, of a Krefine material composition, for controlling the electrical resistance between the first and second housings, being additionally interposed between as well as both axially and radially separating at least the first and second housings, with a tubular insulator housing, of a carbon filled PTFE type material composition, enveloping at least a portion of the first housing. Several embodiments of both in-line and bulkhead type fittings are set forth, one of the latter including frangible screws and an external fracture plane, with an internal controlled weak portion including an internal fracture plane, these fracture planes providing controlled breakaway features.

### CROSS-REFERENCE TO RELATED CASES

The present application claims the benefit of the filing dates of U.S. Provisional Patent Application Ser. No. 60/624,109, filed Nov. 1, 2004 and U.S. Provisional Application Ser. No. 60/672,818, filed Apr. 19, 2005, the disclosures of which are incorporated herein by reference.

### FIELD OF THE INVENTION

The present invention pertains to tubular dielectric fittings for use in applications such as gas to gas, liquid to liquid, gas/liquid to gas/liquid and the like. These dielectric fittings include bulkhead types that are designed to extend through the bulkhead of a vessel, such as an aircraft, and also include in-line types that permit high pressure fluid to travel from side to side.

### BACKGROUND OF THE INVENTION

Dielectric fittings are known in the art and have found use in many applications, ranging from natural gas pipelines, where they isolate monitoring instruments from the effects of electrical current and interrupt cathodic current flow while permitting fluid flow, to providing a conduit for transferring liquid through an aircraft bulkhead. In the latter usage, the dielectric fitting contains integral fitting connections on both sides of the aircraft bulkhead that permit connections of tubes, hoses, or other fluid-carrying components. Such a dielectric fitting also provides a high electrical resistance path that limits electrical current flow between the two fitting connections but allows for the gradual dissipation of p-static charge.

Thus, the primary function of a dielectric fitting, also referred to as a static dissipative hydraulic isolator fitting, is to dissipate the electrical energy from static charges caused in part by fluid movements and the indirect effects of lightning, at such an occurrence. These fittings have the equally important secondary function of providing a safe fluid passage for the fluid passing through the fuel tank or other areas of the aircraft.

The patent literature includes references pertaining to dielectric fittings and references that include individual features that are similar to those utilized in the dielectric fittings of the present invention, with such references including among others: U.S. Pat. No. 5,280,979 to Poli et al.; U.S. Pat. No. 5,628,532 to Ashcraft; U.S. Pat. No. 5,973,903 to Tomerlin; and U.S. Pat. No. 6,129,074 to Frank. Specifically, U.S. Pat. No. 5,280,979 to Poli et al., pertaining to a vacuum pipette with improved electrostatic discharge properties, utilizes a carbon-filled Peek material that has partially conductive properties and a resistor to provide a resistance of 10 to 50 megaohms. The function of this semi-conductive material and the resistor provides one of the functional features of a dielectric fitting; however, the noted structure does not have to pass the high power densities caused by the indirect effects of lightning. Neither does the noted structure need to retain the high pressure fluid of that of the present invention.

The pertinent section of U.S. Pat. No. 5,628,532 to Ashcraft, pertaining to a laminated fuel line and connector, involves the use of a partially conductive O-ring that is capable of resisting any potential electrostatic discharge and allows the release of any static charge. The noted partially conductive seal addresses the concern of static charges causing the breakdown of the seal and creating a potential leakage source. Again, the noted structure does not have any controlled resistance or capability to retain high pressure fluid.

U.S. Pat. No. 5,973,903 to Tomerlin, pertaining to fuel line systems with electric charge buildup prevention, involves a fitting that provides an electrically conductive path for discharging static charge. The noted structure, while being similar to the dielectric fitting of the present invention in that it retains fluid and allows for the discharge of static charge, does not limit the electrical resistance in the fitting to any specific value. In the event of a lightning strike, this non-controlled electrical resistance means that the full power of the lightning strike can pass through the line and into the fuel/air mixtures that may be found inside of an aircraft fuel tank. This reference structure thus permits the full lightning power to pass through the fitting.

U.S. Pat. No. 6,129,074 to Frank, pertaining to the flange of a fuel delivery module and fuel delivery module, utilizes conductive plastic to discharge static build-up that may occur as fluid flows through the assembly or through some other device. While the function of this semi-conductive material is similar to one of the functional features of the present invention, the referenced structure does not have to pass the high power densities caused by the indirect effects of lightning. In addition, the noted structure does not retain the high pressure fluid required of the structure of the dielectric fitting of this invention.

None of the noted prior art references provides the internal 1.5 inch (3.81 cm) minimum linear isolating space for a wetted flow area or the external 3 inch (7.62 cm) minimum linear isolating space for the open air area. These minimum isolating areas are the basic mechanism that prevents an electrical arc while the high voltage static electrical charges are being discharged, with the electrical arc usually causing an explosion in the fuel tank. Furthermore, none of the cited references includes a fitting breakaway feature that works to prevent the structure of an aircraft from being further damaged during an accident.

In contrast thereto, the dielectric structures of the present invention are comprised of a number of features or components that work together to convey, for example, high pressure hydraulic fluid between an inlet and an outlet. These structures simultaneously provide the noted fluid conveyance along with sufficiently high electrical resistance to limit electrical current flow between the fitting connections of the dielectric fitting while still allowing the gradual dissipation of p-static charge.

### SUMMARY OF THE INVENTION

Accordingly, in order to overcome the deficiencies of the prior art devices, the present invention provides a number of embodiments of dielectric tubular fittings for not only dissipating the electrical energy from static charges and large current flows, caused at least in part by fluid movements and the indirect effect of lightning, in case of such an occurrence, but also by providing a safe passage of high pressure fluid therethrough.

Specifically, in terms of structure, in one embodiment of this invention, an in-line type dielectric tubular fitting for dissipating the electric energy from static charges and controlling large current flows, caused at least in part by fluid movements and the indirect effects of lightning, in case of such an occurrence, as well as providing a safe passage of high pressure fluids therethrough, the fitting comprising in combination: a. a stepped, generally tubular base housing; b. a stepped, generally tubular inner housing, coaxial with the base housing; c. a stepped, generally tubular outer housing, coaxial with the inner housing, peripherally, sealingly, surrounding the inner housing, and securing same against rotation relative to the inner housing; d. a stepped, generally tubular first spacer sealingly interposed between as well as both axially and radially separating the inner and base housings; e. a stepped, generally tubular second spacer sealingly interposed between the base, inner and outer housings, and both axially and radially separating at least the base and outer housings; f. a stepped, generally cylindrical electrostatic discharge spacer interposed between and both axially and radially separating at least the base and inner housings, as well as separating the first and second spacers; and g. a generally cup-shaped insulator housing, affixed to the base housing, enveloping the base, inner and outer housings.

A variation of this embodiment further includes a pair of spaced first sealing elements and an adjoining, corresponding, pair of spaced first backup rings, interposed between spaced portions of the first spacer and opposed such portions of the outer housing and the base housing, respectively, with the pair of spaced first sealing elements taking the form of O-rings comprised of an ethylene propylene type material composition; and the pair of first backup rings is comprised of a PTFE type material composition.

Another variation further includes: a. second sealing element interposed between the second spacer and an opposed portion of the outer housing; b. a third sealing element interposed between the second spacer and an opposed portion of the base housing; and c. a fourth sealing element interposed between the inner housing and an opposed portion of the outer housing, with the second, third and fourth sealing elements taking the form of an O-ring comprised of a fluorosilicone type material composition.

In a further variation, the base, inner and outer housings each are comprised of one of a titanium alloy material and an aluminum alloy material composition, wherein the titanium alloy material is of an AL-4V composition and the aluminum alloy material is of a 7075-T73 composition, while the tubular first and second spacers each are comprised of a Peek material composition.

In this embodiment, the tubular first spacer provides a predetermined minimum electrical insulating space from the inner and base housings, with the minimum electrical insulating space being at least 3.81 cm. in addition, the electrostatic discharge spacer is comprised of a Krefine material composition and the insulator housing is comprised of a carbon filled PTFE type material composition.

In a differing variation, the outer housing is secured to the inner housing via intermeshing threads and secured against rotation via a dowel pin, with the tubular base housing including an axially extending inlet portion on one end thereof and the tubular inner housing including an axially extending outlet portion on one end thereof.

In this embodiment, the electrical resistance, ranging from 1×10⁴ to 1×10⁶ ohms, between the base housing and the inner housing, is controlled via the electrostatic discharge spacer and the path of the controlled electrical resistance proceeds axially outwardly from the inner housing to the base housing via the interposed electrostatic discharge spacer and vise versa.

Furthermore, the insulator housing provides a predetermined first minimum surface length of linear insulating distance and a predetermined second minimum line-of-sight distance insulating distance, with the first and second insulating distances being at least 7.62 cm. and 2.54 cm., respectively.

In a variation thereof, the generally tubular inner housing further includes an axial extension member on one end thereof, the extension member including a hub portion and a coaxial generally disc-shaped portion, located intermediate the extension member and the one end of the inner housing, with the one end of the tubular inner housing, at the extension member, including a peripheral controlled weak portion. This variation further includes an insulator member having a central tubular hub, coaxial with the extension member, and a ring portion having a first annular end surface abutting a corresponding annular end surface of the disc-shaped portion of the extension member, with the addition of the disc-shaped portion and the insulator member modifying the construction of the in line type dielectric fitting to that of a bulkhead type dielectric fitting adapted to at least partially axially extend through an aperture in the bulkhead of a vessel. The ring portion has a second annular end surface abutting a corresponding annular end surface of the bulkhead and the disc-shaped portion has a plurality of peripherally-spaced, radially outwardly directed first flange portions, with each of the first flange portions having a first aperture and the ring portion having a plurality of peripherally-spaced, radially outwardly-directed second flange portions, with each of the second flange portions having a second aperture, the first and second apertures being coaxial and serving for mounting purposes. In addition, the one end of the tubular inner housing includes, at the extension member, a peripheral controlled weak portion.

Another embodiment of this invention pertains to a bulkhead-type dielectric tubular fitting, extending through an aperture in the bulkhead of a vessel, for dissipating the electric energy from static charges and controlling large current flows caused by at least in part by fluid movements and the indirect effects of lightning, in case of such an occurrence, as well as providing safe passage of high pressure fluids therethrough, the fitting comprising in combination: a. a stepped, generally tubular, inner housing, having an outlet portion on one end thereof; b. a stepped, generally tubular, outer housing, coaxial with the inner housing; c. a stepped, generally tubular, spacer sealingly interposed between and both axially and radially separating the inner and outer housings; d. a stepped, generally disc-shaped, first electrostatic discharge spacer interposed between and both axially and radially separating at least the inner and outer housings; e. a stepped, generally disc-shaped second electrostatic discharge spacer sealingly interposed between the inner housing and an adjoining side of the bulkhead; f. a generally tubular insulator housing, affixed to the inner housing, enveloping a cylindrical portion of the inner housing and abutting an annular end portion of the second electrostatic discharge spacer; g. a generally ring-shaped mounting bolt housing, abutting adjoining portions of the inner housing and the second electrostatic discharge spacer, having a spaced plurality of axial mounting bolt apertures axially and rotationally aligned with a corresponding such mounting bolt aperture in the second electrostatic discharge spacer; h. a generally ring-shaped screw housing, abutting adjoining portions of the outer housing and the first electrostatic discharge spacer, having a spaced plurality of screw apertures axially and rotationally aligned with corresponding such screw apertures in the first electrostatic discharge spacer and a disc-shaped portion of the inner housing; i. a plurality of screws, each screw extending through one of the screw apertures and corresponding screw apertures for secured engagement with a corresponding one of a plurality of screw retention inserts located in the corresponding screw apertures in the inner housing disc-shaped portion; j. a ring washer having a plurality of apertures, corresponding with the screw apertures, interposed between the plurality of screws and an adjoining side of the screw housing; k. a tubular adaptor, coaxial with and sealingly attached to an inlet portion of the tubular outer housing; and l. a generally cup-shaped insulator boot having a base portion, attached at least to the screw housing, and an outwardly flared portion surrounding at least the adaptor.

One variation thereof further includes a pair of spaced first sealing elements and an adjoining, corresponding, pair of first backup rings, interposed between separated portions of the tubular spacer and opposed such portions of the outer housing and the inner housing, respectively, with the pair of spaced first sealing elements takes the form of O-rings comprised of an ethylene propylene type material composition; and the pair of first backup rings is comprised of a PTFE type material composition.

A further variation includes: a. a second sealing element interposed between the second electrostatic discharge spacer and an adjoining outer surface of the bulkhead; b. a third sealing element and an adjoining second backup ring interposed between the second electrostatic discharge spacer and an opposed portion of the inner housing; and c. a fourth sealing element interposed between the outer housing and an opposed portion of the tubular adaptor, with the second, third and fourth sealing elements each taking the form of an O-ring comprised of a fluorosilicone type material composition.

In a differing variation, the tubular adaptor as well as the inner and outer housings are comprised of one of a titanium alloy material composition and an aluminum alloy material composition, with the tubular spacer as well as the mounting bolt housing and the screw housing are comprised of a Peek material composition.

In another variation, the first and second electrostatic discharge spacers are comprised of a Krefine material composition, while the insulator housing is comprised of a carbon filled PTFE type material composition. The tubular inner housing includes an axially extending outlet portion on one end thereof, with the outlet portion including, at a predetermined axial distance from the bulkhead, a peripheral controlled weak portion as well as an internal fracture plane passing perpendicularly through the controlled weak portion, thereby providing a controlled inner breakaway feature.

In another embodiment, the control of the electrical resistance, ranging from 1×10⁴ to 1×10⁶ ohms, between the outer housing and the inner housing is controlled via the first and second electrostatic discharge spacers, with the path of the controlled electrical resistance proceeds from the bulkhead, via the second electrostatic discharge spacer, to the inner housing and, via the first electrostatic discharge spacer, to the outer housing, and from the inner housing, through the first electrostatic discharge spacer, to the outer housing and vice versa, and the second electrostatic discharge spacer also serving as a thermal barrier between a higher temperature fluid, passing through the tubular fitting, and the bulkhead.

In another variation, the plurality of screws and the ring washer are comprised of a CRES 15-5PH material composition and the plurality of screw retention inserts is comprised of a stainless steel alloy material, with the screws being frangible screws. This variation further includes an external fracture plane, axially outwardly at a predetermined distance from the bulkhead, thereby providing a controlled external breakaway feature, with the external fracture plane essentially passing through the threaded portion of the frangible screws, adjoining the locking screw inserts in the inner housing.

In this embodiment, the insulator boot is comprised of a silicon type material composition and the tubular spacer provides a predetermined minimum electrical insulating space, on the inner side of the bulkhead, which electrically isolates the inner housing from the outer housing, with the minimum electrical insulating space being at least 3.81 cm. In addition, the insulator boot provides a predetermined first minimum surface length of linear insulating space and a predetermined second minimum line-of-sight insulating distance, on the outer side of the bulkhead, that prevents the portion of the fitting, on the outside of the bulkhead, form from creating an electrical path, with the first and second insulating distances being at least 7.62 cm. and 2.54 cm., respectively.

A further embodiment of this invention pertains to a bulkhead-type dielectric fitting, extending through an aperture in the bulkhead of a vessel, for dissipating the electrical energy from static charges and controlling large current flows, caused by at least in part by fluid movements and the indirect effects of lightning, in case of such an occurrence, as well as providing a safe passage of high pressure fluids therethrough, the fitting comprising in combination: a. a stepped, generally tubular, inner housing; b. a stepped, generally tubular, outer housing, coaxial with the inner housing; c. a stepped, generally tubular, spacer sealingly interposed between and both axially and radially separating the inner and outer housings; d. a stepped, generally disc-shaped, first electrostatic discharge spacer interposed between and both axially and radially separating at least the inner and outer housings; e. a stepped, generally disc-shaped second electrostatic discharge spacer sealingly interposed between the inner housing and an adjoining side of the bulkhead; f. a generally tubular insulator housing, affixed to the inner housing, enveloping a cylindrical portion of the inner housing, and abutting an annular end portion of the second electrostatic discharge spacer; g. a generally ring-shaped mounting bolt housing, abutting adjoining portions of the inner housing and the second electrostatic discharge spacer, having a spaced plurality of axial mounting bolt apertures axially and rotationally aligned with corresponding such mounting bolt apertures in the bulkhead and the second electrostatic discharge spacer; h. a generally ring-shaped screw housing, abutting adjoining portions of the outer housing and the first electrostatic discharge spacer, having a spaced plurality of screw apertures axially and rotationally aligned with corresponding such screw apertures in the first electrostatic discharge spacer and a disc-shaped portion of the inner housing; i. a plurality of screws, each screw extending through one of the screw apertures and corresponding screw apertures for secured engagement with a corresponding one of a plurality of screw retention inserts located in corresponding screw apertures in the inner housing disc-shaped portion; j. a first tubular adaptor, coaxial with and sealingly attached to an inlet portion of the tubular outer housing; and k. a generally cup-shaped insulator boot having a peripheral portion thereof attached at least to the mounting bolt housing, and an annular outer end face covering the mounting bolt and screw housings. A variation thereof includes a second tubular adaptor, coaxial with and sealingly attached to an outlet portion of the tubular inner housing.

An other variation thereof further includes first and second anti-rotation mechanisms that serve to transmit torques, occurring during the installation of the fitting, back to the bulkhead, with the first and second anti-rotation mechanisms respectively including a first set of intermeshing, matching, teeth on the outer housing and the screw housing and a second set of intermeshing, matched, teeth on the inner housing and the mounting bolt housing.

A differing embodiment of this invention also pertains to a bulkhead-type dielectric fitting, extending through an aperture in the bulkhead of a vessel, for dissipating the electrical energy from static charges and controlling large current flows, caused by at least in part by fluid movements and the indirect effects of lightning, in case of such an occurrence, as well as providing safe passage of high pressure fluids therethrough, the fitting comprising in combination: a. a stepped, generally tubular, inner housing; b. a stepped, generally tubular, outer housing, coaxial with the inner housing; c. a stepped, generally tubular spacer sealingly interposed between as well as both axially and radially separating the inner and outer housings; d. a stepped, generally disc-shaped, first electrostatic discharge spacer interposed between as well as both axially and radially separating at least the inner and outer housings; e. a stepped, generally disc-shaped second electrostatic discharge spacer sealingly interposed between the inner housing and an adjoining side of the bulkhead; f. a stepped, generally tubular insulator housing, affixed to the inner housing, enveloping a cylindrical portion of the inner housing and abutting an annular end portion of the second electrostatic discharge spacer; g. a generally ring-shaped mounting bolt housing, abutting adjoining portions of the inner housing and the second electrostatic discharge spacer, having a spaced plurality of axial mounting bolt apertures axially and rotationally aligned with corresponding such apertures in the second electrostatic discharge spacer; h. a generally ring-shaped screw housing, abutting adjoining portions of the outer housing and the first electrostatic discharge spacer, having a spaced plurality of screw apertures axially and rotationally aligned with corresponding such screw apertures in the first electrostatic discharge spacer and a disc-shaped portion of the inner housing; i. a plurality of screws, each screw extending through one of the screw apertures and corresponding screw apertures for secured engagement with a corresponding one of a plurality of screw retention inserts located in corresponding screw apertures in the inner housing disc-shaped portion; j. at least one tubular adaptor, coaxial with and sealingly attached to at least one of an inlet portion of the outer housing and an outlet portion of the inner housing; and k. a generally cup-shaped insulator boot having a peripheral portion attached at least to one of the screw and mounting bolt housings.

A variation thereof further includes a ring washer having a plurality of apertures, corresponding with the screw apertures, interposed between the plurality of screws and an adjoining side of the screw housing, with the insulator boot further including an outwardly flared portion surrounding at least the adaptor and an annular outer end face covering the outer end faces of the mounting bolt and screw housings.

A yet another embodiment of this invention pertains to an in-line type dielectric tubular fitting for dissipating the electrical energy from static charges and controlling large current flows caused by at least in part by fluid movements and the indirect effects of lightning, in case of such an occurrence, as well as providing a safe passage of high pressure fluid therethrough, the fitting comprising in combination: a. a stepped, generally tubular outer housing having a first large diameter inside surface portion separated from a first small diameter inside surface portion by a first annular step surface; b. a stepped, generally tubular inner housing, defining a central cavity, having a second large diameter inside surface portion separated from a second small diameter inside surface portion by a second annular step surface, the second large diameter inside surface portion including an outside surface portion, with a predetermined axial section thereof extending into and being fixedly secured to the outer housing first large diameter inside surface portion, with the second large diameter inside surface portion together with the first and second small diameter inside surface portions defining a stepped central through bore including the central cavity and opposed first and second small diameter cylindrical end surface portions; c. a first, generally tubular, stepped adaptor having a first inner annular end surface and adjoining spaced first inner and outer radial flange portions, located within the inner housing central cavity, as well as having a first axially outwardly directed small diameter tubular portion extending axially outwardly through the outer housing first small diameter inside surface portion; d. second, generally tubular, stepped adaptor having a second inner annular end surface and adjoining spaced second inner and outer radial flange portions, also located within the inner housing central cavity, as well as having a second axially outwardly directed small diameter tubular portion extending axially outwardly through the inner housing second small diameter inside surface portion; e. a generally tubular center dielectric insulator located within the central cavity and sealingly radially interposed between the central cavity and the inner and outer first and second flange portions of each of the first and second adaptors, the center dielectric insulator also including a radially inwardly-directed center flange portions interposed between the first and second inner annular end surfaces of the first and second adaptors; f. a first, generally tubular, stepped, end dielectric insulator, located in one end of the inner housing stepped bore, having a first inner end portion abutting an adjoining end portion of the center dielectric insulator, having a first outer end portion interposed between the outer housing first small diameter inside surface portion and a cylindrical portion of the first adaptor small diameter tubular portion, and having a first intermediate annular portion joining the first inner and outer end portions; and g. a second, generally tubular, stepped, end dielectric insulator, located in another end of the stepped bore, having a second inner end portion abutting another adjoining end portion of the center dielectric insulator, having a second outer end portion interposed between the inner housing second small diameter inside surface portion and a cylindrical portion of the second adaptor small diameter tubular portion, and having a second intermediate annular portion joining the second inner and outer end portions.

One variation further includes, in each of first and second axial recesses between the first and second inner and outer radial flange portions of the first and second adaptors, respectively, of a central, annular, seal member and a pair of adjoining, opposed, backup rings, with the seal member taking the form of an O-ring, comprised of an ethylene propylene type material composition and the pair of backup rings is comprised of a PTFE type material composition.

In another variation thereof, the inner and outer housings, as well as the first and second adaptors, are each comprised of a titanium alloy material, with the center dielectric insulator as well as the first and second end dielectric insulators each are comprised of ULTEM® 2300 material.

A differing variation further includes a radially outwardly-directed further flange portion and the inner housing includes a still further radially outwardly-directed flange portion, with the addition of the further and still further flange portions modifying the construction of the in-line type dielectric fitting to that of a bulkhead-type dielectric fitting which extends through an aperture in the bulkhead of a vessel.

The previous variation further includes, in each of first and second axial recesses between the first and second inner and outer radial flange portions of the first and second adaptors, respectively, the addition of a central, annular, seal member and a pair of adjoining, opposed, backup rings, with the seal member taking the form of an O-ring, comprised of an ethylene propylene type material composition and the pair of backup rings is comprised of a PTFE type material composition. The inner and outer housings, as well as the first and second adaptors, each are comprised of a titanium alloy material, while the center dielectric insulator as well as the first and second dielectric insulators each are comprised of ULTEM® 2300 material.

A still further embodiment of the present invention pertains to a dielectric, generally tubular, fitting, for dissipating the electrical energy from static charges and controlling large current flows, caused at least in part by fluid movements and the indirect effects of lightning, in case of such an occurrence, as well as providing safe passage of high pressure fluids therethrough, the fitting including: a. at least one stepped, generally tubular metallic first housing; b. at least one stepped, generally tubular second metallic housing, coaxial with the first housing; c. a stepped, generally tubular first spacer sealingly interposed between as well as both axially and radially separating the at least ones of the first and second housings; d. at least one stepped, generally disc-shaped first electrostatic discharge spacer, interposed between as well as both axially and radially separating the at least ones of the first and second housings; and e. at least one stepped, generally tubular insulator housing, enveloping at least a portion of one of the at least one of the first and second housings.

One variation of this still further embodiment further includes a. a third generally tubular metallic housing, coaxial with the first and second housings; and b. a stepped, generally tubular second spacer sealingly interposed between at least two of the first, second and third housings, and both axially and radially separating at least two of said first, second and third housings, the fitting being one of an in-line type and a bulkhead type fitting.

In the previous variation, the first electrostatic discharge spacer is comprised of a Krefine, EKH-SS07 material composition, while the electrical resistance between the first and one of the second and third housings is controlled via the first electrostatic discharge spacer, with the path of the electrical resistance proceeding axially outwardly from the first housing to one of the second and third housings via the interposed first electrostatic discharge spacer and vise versa.

In a further variation, generally tubular first housing also includes an axial extension member on one end thereof, the extension member including a hub portion and a coaxial generally disc-shaped portion, located intermediate the extension member and the one end of the first housing and further includes an insulator member having a central tubular hub, coaxial with the extension member, and a ring portion having a first annular end surface abutting a corresponding annular end surface of the disc-shaped portion of the extension member, with the addition of the disc-shaped portion and the insulator member modifying the construction of the in-line dielectric fitting to that of a bulkhead type fitting adapted to at least partially extend through an aperture in the bulkhead of a vessel. In addition, the one end of the tubular first housing includes, at the extension member, a peripheral controlled weak portion.

In the previous variation, the tubular first spacer provides a minimum of at least 3.81 cm. of electrical insulating space from the first and third housings and the insulator housing provides a predetermined first minimum of at least 7.62 cm. of linear insulating distance and a second minimum of at least a 2.54 cm. line-of-sight distance insulating space.

In an additional variation of the previous embodiment, the fitting being a bulkhead-type fitting, extending through an aperture in the bulkhead of a vessel, the fitting further including: a. a. stepped, generally disc-shaped second electrostatic discharge spacer, sealingly interposed between the first housing and an adjoining side of the bulkhead; b. a generally ring-shaped mounting bolt housing, abutting adjoining portions of the first housing and the second electrostatic discharge spacer, having a spaced plurality of axial mounting bolt apertures axially and rotationally aligned with corresponding such apertures in the bulkhead and the second electrostatic discharge spacer; c. a generally ring-shaped screw housing, abutting adjoining portions of the second housing and the first electrostatic discharge spacer, having a plurality of screw apertures axially and rotationally aligned with corresponding such screw apertures in the first electrostatic discharge spacer and a disc-shaped portion of the first housing; d. a plurality of screws, each screw extending through one of the screw apertures and corresponding screw apertures for secured engagement with a corresponding one of a plurality of screw retention inserts located in the corresponding screw apertures in the first housing disc-shaped portion; e. at least one tubular adaptor, coaxial with and sealingly attached to at least one of an inlet portion of the second housing and an outlet portion of the first housing; and f. a generally cup-shaped insulator boot having a peripheral portion attached at least to one of the screw and mounting bolt housings.

A modification of the previous embodiment further includes a ring washer having a plurality of spaced apertures, corresponding with the screw apertures, interposed between the plurality of screws and an adjoining side of the screw housing. In a further modification, the first and second electrostatic discharge spacers are comprised of a Krefine material composition.

In a differing modification, the first housing includes an axially extending outlet portion, on one end thereof, the outlet portion having, at a predetermined axial distance from the bulkhead, a peripheral controlled weak portion, with a first fracture plane passing through the controlled weak portion, thereby providing a controlled first breakaway feature.

In the noted another variation, the control of the electrical resistance, between the second and first housings, is controlled via the first and second electrostatic discharge spacers, with the path of the controlled electrical resistance proceeding from the bulkhead, via the second electrostatic discharge spacer, to the first housing and, via the first electrostatic discharge spacer, to the second housing, and from the first housing, through the first electrostatic discharge spacer, to the second housing and vice versa. In this variation, the screws are frangible screws, with the fitting further including a second fracture plane essentially passing through the threaded portion of the frangible screws, adjoining the locking screw inserts, thereby providing a controlled second breakaway feature.

In addition, the tubular spacer provides a minimum of at least 3.81 cm. of electrical insulating space, on the inner side of the bulkhead, which electrically isolates the first housing from the second housing. Furthermore, the insulator boot provides a first surface length of at least 7.62 cm. of linear insulating space and a second line-of-sight insulating distance of at least 2.54 cm., on the outer side of the bulkhead, that prevent the portion of the fitting, on the outside of the bulkhead, from creating an electrical path.

An additional embodiment of this invention pertains to an in-line type dielectric tubular fitting for dissipating the electrical energy from static charges, caused at least in part by fluid movements and the indirect effects of lightning, in case of such an occurrence, as well as providing a safe passage of fluids therethrough, the fitting comprising in combination: a. a pair of coaxial, oppositely-directed, stepped, tubular inner housings; b. a pair of coaxial, oppositely-directed, stepped, tubular outer housings, with a first one of the pair of outer housings being coaxial with and peripherally surrounding a first one of the pair of inner housings, with a second one of the pair of outer housings being coaxial with and surrounding a second one of the pair inner housings, the second one of the pair of outer housings including an axially further extending intermediate portion, with the intermediate portion being peripherally surrounded by the first one of the pair of outer housings and securing same against relative rotation therebetween; c. a stepped, generally tubular, first spacer sealingly interposed between as well as both axially and radially separating the pair of inner housings; d. a pair of coaxial, oppositely-directed, stepped, generally tubular second spacers, with a first one of the pair of second spacers being interposed between the first one of the pair of inner housings and the intermediate portion for both axially and radially separating the first one of the pair of inner housings and the intermediate portion, with a second one of the pair of second spacers being interposed between the second one of the pair of inner housings and the second one of the pair of outer housings for both axially and radially separating the second one of the pair of inner housings and the second one of the pair of outer housings; e. a pair of coaxial, oppositely-directed, stepped, generally cylindrical electrostatic discharge spacers, with a first one of the pair of electrostatic discharge spacers being interposed between and separating the first one of pair of inner housings from at least the first one of the pair of outer housings and, with a second one of the pair of electrostatic discharge spacers being interposed between and separating the second one of the pair of inner housings from at least the second one of the pair of outer housings; and f. a pair of coaxial, oppositely-directed, generally cup-shaped insulator housings, with a first one of the pair of insulator housings enveloping at least a single one of the first ones of the pairs of inner and outer housings and, a second one of the pair of insulator housings enveloping at least a single one of the second ones of the pairs of inner and outer housings.

A variation thereof further includes, at about the junction of the second one of the pair of outer housings with the further axially extending intermediate portion thereof, a radially outwardly directed flange portion, with the flange portion including at least one axially directed through aperture.

### BRIEF DESCRIPTION OF THE DRAWINGS

FIG. 1 is a perspective view, in longitudinal vertical cross section, of a first embodiment of the dielectric fitting of this invention.

FIG. 2A is a frontal view, in longitudinal vertical half cross section, of the dielectric fitting of FIG. 1.

FIG. 2B is a view, similar to that of FIG. 2A, but showing a variation thereof.

FIG. 3 is a view of the outer end of the bulkhead bolt used in the fitting of FIG. 1.

FIG. 4 is a frontal view, in longitudinal vertical half cross section, of the bulkhead bolt of FIG. 3.

FIG. 5 is a view of the outer end of the bulkhead nut used in the fitting of FIG. 1.

FIG. 6 is a frontal view, in longitudinal vertical half cross section, of the bulkhead nut of FIG. 5.

FIG. 7 is a view of the outer end of one of the adapters used in the fitting of FIG. 1.

FIG. 8 is a frontal view, in longitudinal vertical half cross section, of the adapter of FIG. 7.

FIG. 9 is a view of the outer end of the center dielectric insulator of the fitting of FIG. 1.

FIG. 10 is a frontal view, in longitudinal vertical half cross section, of the center dielectric insulator of FIG. 9.

FIG. 11 is a view of the outer end of one of the end dielectric insulators of the fitting of FIG. 1.

FIG. 12 is a frontal view, in longitudinal vertical half cross section, of the end dielectric insulator of FIG. 11.

FIG. 13 is a perspective view of a second embodiment of the dielectric fitting of this invention.

FIG. 14 is a perspective view of a third embodiment of the dielectric fitting of this invention.

FIG. 15 is a frontal view, with parts broken away, of the dielectric fitting of FIG. 13.

FIG. 16 is a view of the outer end of the fitting of FIG. 13.

FIG. 17 is a sectional view, taken along line 17-17 of FIG. 16.

FIG. 18 is a sectional view, with parts broken away, taken along line 18-18 of FIG. 15.

FIG. 19 is a frontal view of the dielectric fitting of FIG. 14.

FIG. 20 is a view of one end of the fitting of FIG. 19.

FIG. 21 is a sectional view, taken along line 21-21 of FIG. 20.

FIG. 21A is a view, similar to that of FIG. 21 but showing a variation thereof.

FIG. 22 is a longitudinal vertical half cross sectional view of the dielectric fitting of FIG. 13, showing the controlled electric resistance path therethrough.

FIG. 23 is a longitudinal vertical half cross sectional view of the dielectric fitting of FIG. 14, showing the controlled electric resistance path therethrough.

FIG. 24 is a frontal view, in longitudinal vertical half cross section, of a fourth embodiment of the dielectric fitting of this invention.

FIG. 25 is a longitudinal view, similar to that of FIG. 21, but showing a variation thereof.

FIG. 26 is a full end view, from the right, of the dielectric fitting of FIG. 25.

FIG. 27 is a longitudinal view, in vertical half cross section of another embodiment of the dielectric fittings of this invention.

FIG. 28 is a full end view, from the right, of the dielectric fitting of FIG. 27.

### DETAILED DESCRIPTION OF THE INVENTION

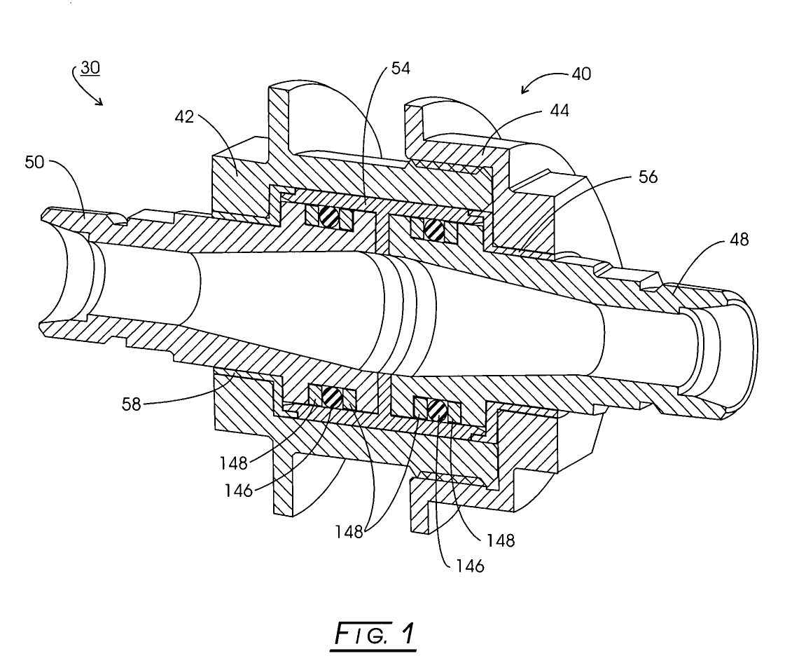

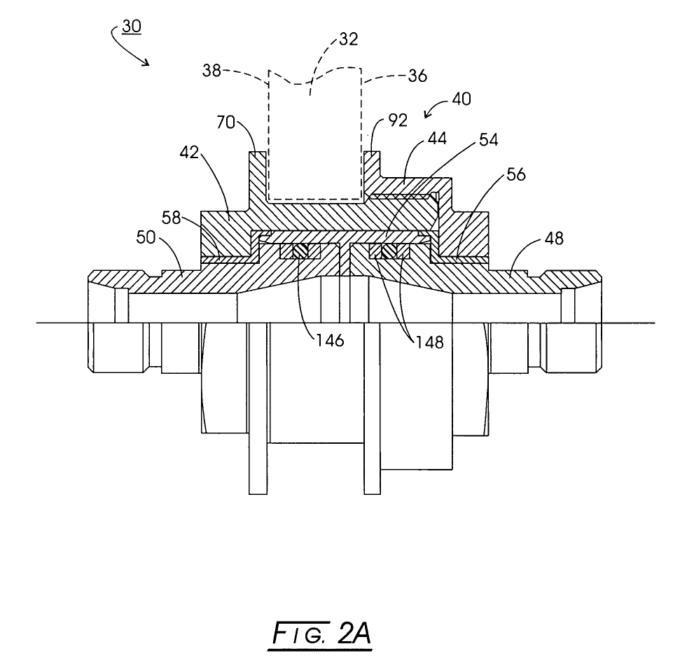

Referring now to the multiple drawings, illustrated in FIGS. 1-12 is a first embodiment 30 and a variation 30′ of one of the several dielectric fittings of this invention. Dielectric fitting 30 is defined as a bulkhead-type fitting since it is designed to extend through a bulkhead 32 (FIG. 2) of a vessel, such as an aircraft, with bulkhead 32 including an air side or outer side 36 and a fuel side or inner side 38. It should be understood that dielectric fittings, such as fitting 30, can be used in a many other applications, such as gas to gas, liquid to liquid, gas/liquid to gas/liquid, or the like. Fitting 30, as best seen in FIGS. 1 and 2A, basically includes a housing 40, comprised of bulkhead bolt or inner housing 42 and bulkhead nut or outer housing 44; a pair of oppositely-directed, generally tubular and substantially similar adapters 48 and 50; a center dielectric insulator 54; and a pair of oppositely-directed, generally tubular and substantially similar end dielectric insulators 56 and 58.

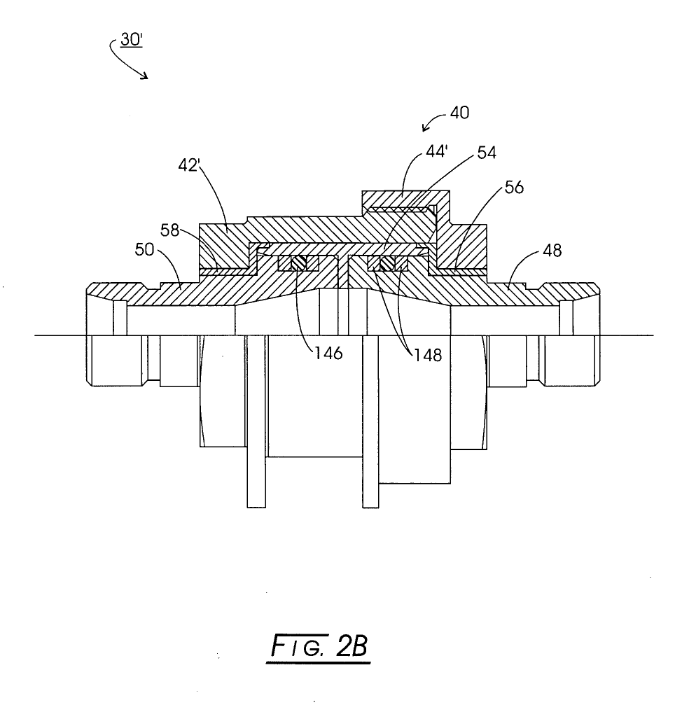

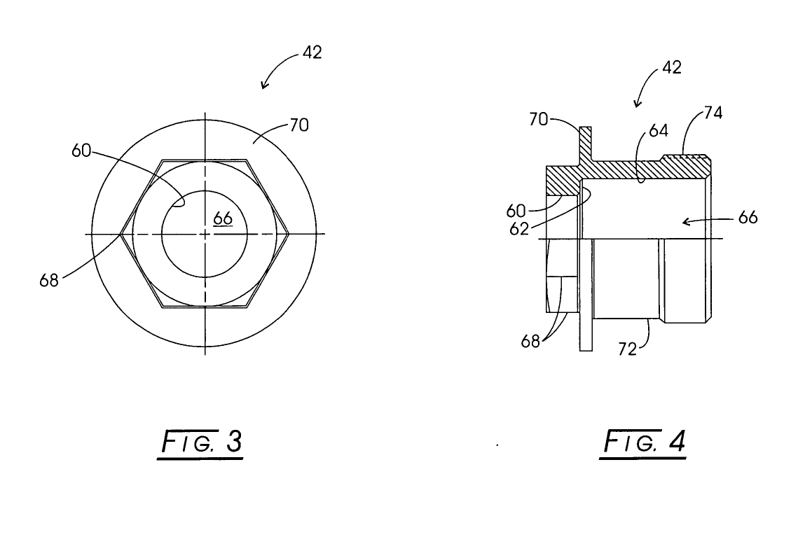

Turning to the details of the above-noted structural parts, FIGS. 3 and 4 illustrate generally tubular bulkhead bolt or inner housing 42 as including a small diameter inner peripheral surface portion 60, separated from a larger diameter inner peripheral surface portion 64 by an annular step surface 62, with surface portions 60 and 64 defining a center through bore 66. The outer peripheral surface of bulkhead bolt 42 includes an inner, multiple-flat surface tool portion 68; an adjoining, radially outwardly-directed, flange portion 70; and a generally cylindrical portion 72, having a threaded outer end portion 74.

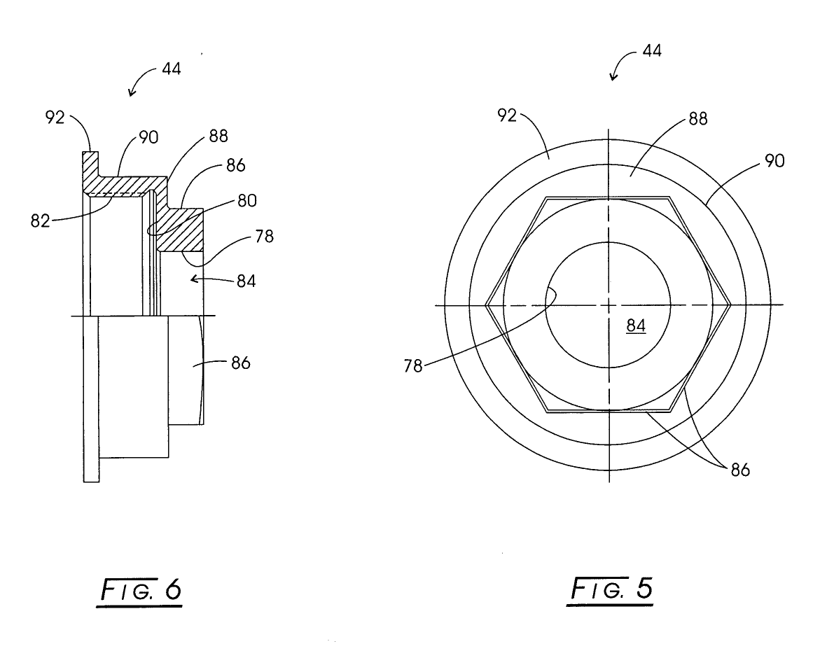

FIGS. 5 and 6 illustrate generally tubular bulkhead nut or outer housing 44 as including a small diameter inner peripheral surface portion 78, separated from a larger, threaded, inner peripheral surface portion 82 by an annular step surface 80, with surface portions 78 and 82 defining a central through bore 84, coaxial with bulkhead bolt through bore 66. The outer peripheral surface of bulkhead nut 44 includes an outer, multiple-flat surface tool portion 86; an adjoining step portion 88; a generally cylindrical portion 90; and a radially, outwardly-directed, flange portion 92.

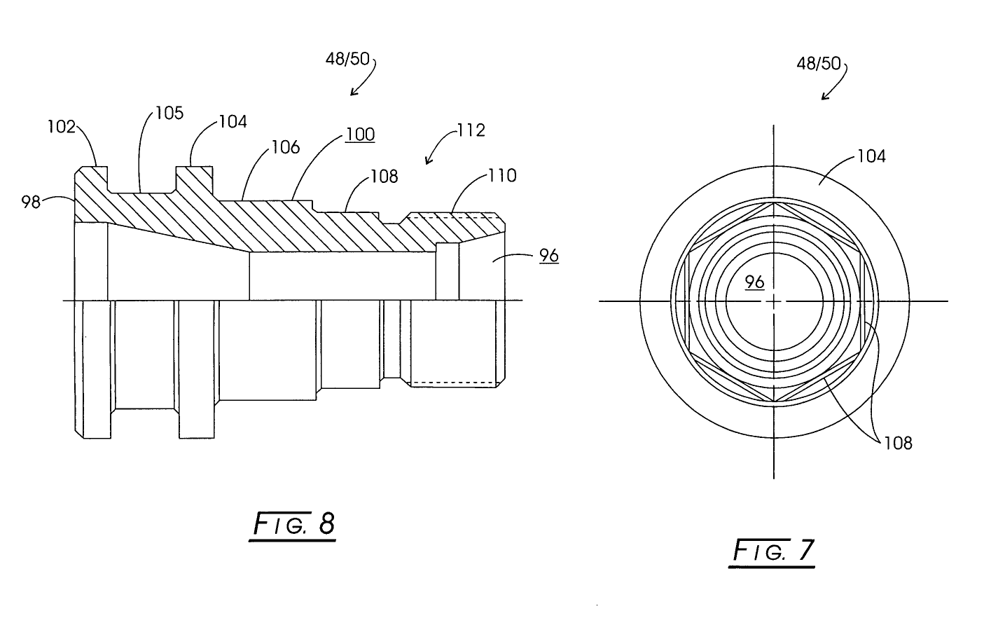

FIGS. 7 and 8 illustrate generally tubular adapter 48 as including a multiple-angled or tapered central through bore 96, merging into an inner annular end surface 98 that also includes a side surface of a first flange portion 102 that is radially outwardly-directed from the inner end of an outer surface 100 which also includes a spaced, second, radially outwardly-directed flange portion 104 as well as an adjoining cylindrical portion 106, a multiple flat-surface tool portion 108 and a threaded portion 110. As best seen in FIG. 1, inserted in recessed space 105 (FIG. 8) between respective first and second flange portions 102, 104 of each of adapters 48 and 50, is a seal member 146, such as an O-ring, preferably of a fluorosilicone, e.g., MIL-R-25988 composition, with seal member 146 being interposed between opposed annular backup rings 148, preferably of a TEFLON®, e.g., MIL-R-8791 composition. Tubular adaptor 50 is the same as adaptor 48 but is oppositely directed.

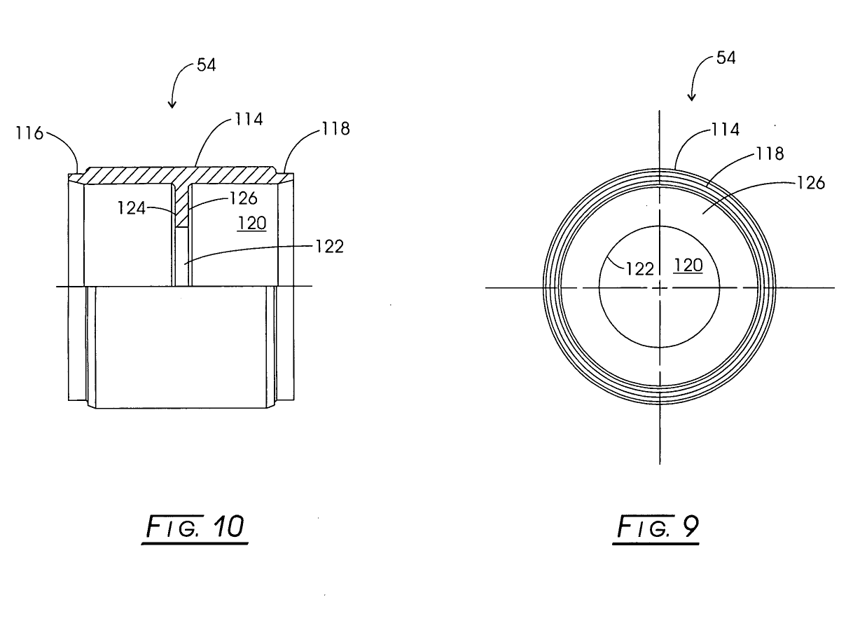

FIGS. 9 and 10 illustrate generally tubular center dielectric insulator 54 as including a generally tubular outer peripheral surface 114 having oppositely-directed, smaller diameter, end portions 116, 118, and an inner peripheral surface 120 that includes a radially, inwardly-directed, center flange 122 having opposed annular end faces 124, 126.

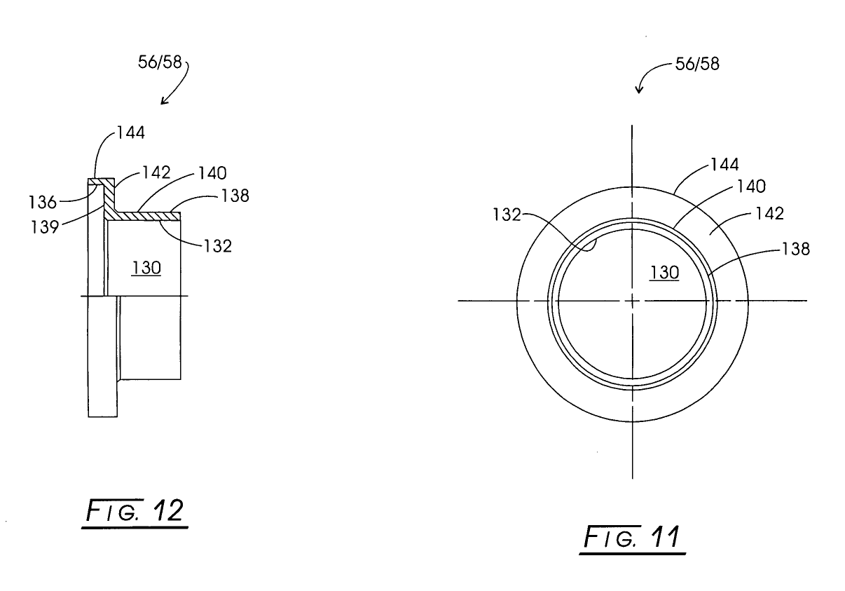

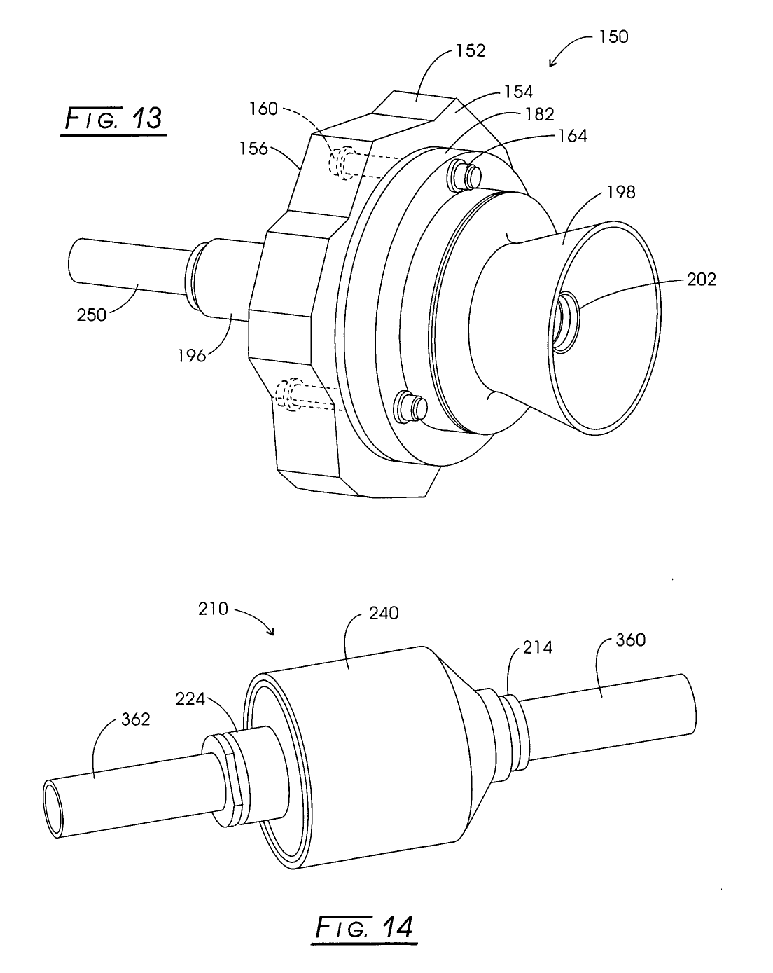

FIGS. 11 and 12 illustrate generally tubular end dielectric insulator 56, including a through bore 130, comprised of small diameter portion 132 and larger diameter portion 136, separated by an inner step surface 134. The outer peripheral surface 138 of end dielectric insulator 56 includes a small diameter portion 140 and a larger diameter portion 144, separated by an outer step surface 142. Tubular insulator 58 is the same as insulator 56 except that it is oppositely directed.

In terms of materials, bulkhead bolt or inner housing 42 and bulkhead nut or outer housing 44, as well as adapters 48 and 50 are preferably made of a light metal, to minimize weight, such as, for example, of titanium alloy, type AL-4V, as per AMS 4928, with the coupling end portions 112, of adaptors 48, 50, preferably being configured as per Aerospace Standards AS4375. Center dielectric insulator 54 and end dielectric insulators 56, 58 are preferably comprised of a 30% glass fiber filled, standard flow polyetherimide (Tg 217C), ECO conforming, UL94 V0 and 5VA listing material, commercially sold and distributed by the General Electric Company under the trade name ULTEM® 2300. Turning now to the assembly process of dielectric fitting 30, again as best seen in FIGS. 1, 2A and 2B, initially, seal member 146, together with its opposed backup rings 148 is stretched to fit within each of the adapter recess spaces 105 in each of adaptors 48 and 50. Then, the just-noted subassemblies are oppositely inserted into center dielectric insulator 54 until adaptor end faces 98 abut insulator opposed annular end faces 124, 126. This step is followed by the placement of end dielectric insulators 56 and 58 onto adaptors 48 and 50, respectively, until the large diameter portions 144 of end insulators 56 and 58 override opposed smaller diameter end portions 118, 116 (FIG. 10), respectively, of center insulator 54. The resulting assembly is then interference-fitted, such as via press fitting, into the large diameter inner peripheral surface 64 (FIG. 4) of bulkhead bolt 42. The noted interference fit is required so as to prevent expansion of insulators 56 and 58, under pressure, thereby maintaining the necessary gap at the sealing surfaces of sealing members 146. Finally, the assembly process is completed when bulkhead nut 44 is secured to bulkhead bolt 42 via the interaction of threaded portions 74 and 82. It is, of course, the function of completed dielectric fitting 30 to provide or permit the flow of fluid therethrough while preventing a non-controlled electrical current path through fitting 30. The noted construction prevents a non-controlled electrical current path both from fitting end to fitting end as well as from the bulkhead to the fitting end. The shown coupling or fitting end may need to be revised in order to meet the specific requirements of differing end users. In addition, the selection of a specific Electrostatic Discharge (ESD) material can provide a plurality of choices for electrical resistance to satisfy the particular needs of the application.

Continuing on to FIG. 2B, illustrated therein is a further embodiment of this invention, namely a variation 30′ of previously discussed bulkhead-type dielectric fitting 30 of FIG. 2A. Specifically, bulkhead-type fitting 30 has been modified, so as to produce an in-line dielectric fitting 30′, by deleting flanges 70 and 92 on bulkhead bolt 42 and bulkhead nut 44, respectively, from fitting 30. All other components, except for bulkhead bolt 42′ and bulkhead nut 44′, remain substantially the same as in fitting 30 and, in the interest of brevity, will not be reiterated.

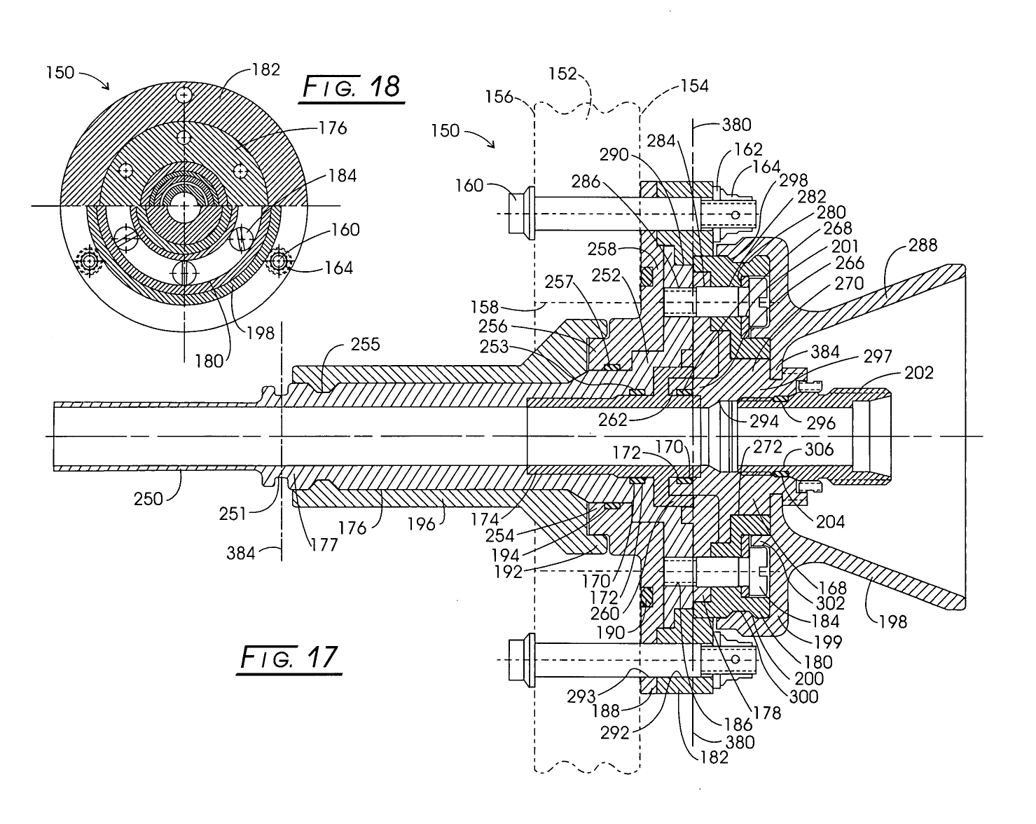

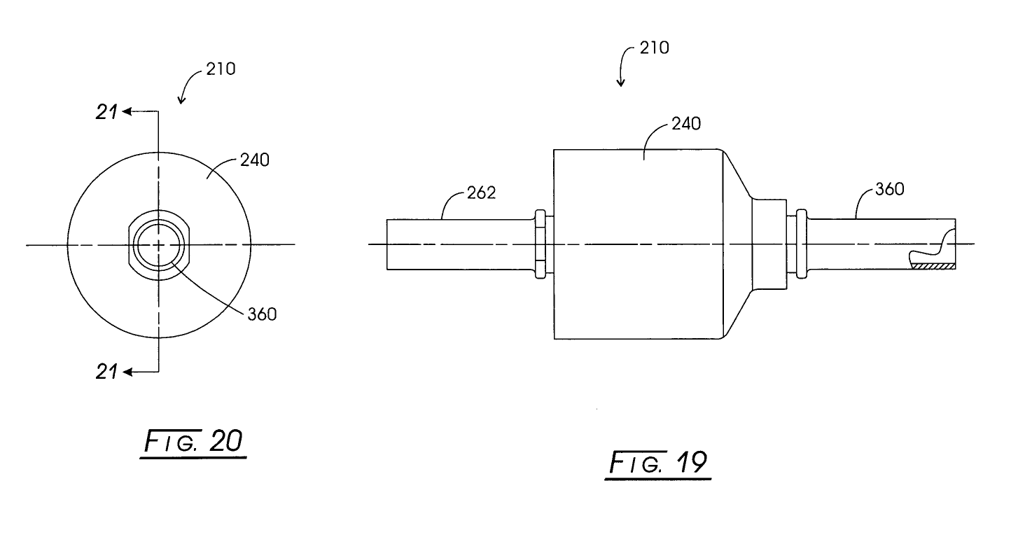

Turning now to another embodiment of this invention, illustrated in FIGS. 13, 15-18 and 22, is another bulkhead-type dielectric fitting 150. As best seen in FIGS. 13, 15 and 17, fitting 150 is secured to a vessel bulkhead or mounting 152, having an air side 154 and a fuel side 156, with a plurality of preferably evenly peripherally spaced mounting bolts 160; washers 162 and self-locking nuts 164. Fitting 150 basically includes an airside housing 168; a pair of spaced first O-rings 170; a pair of spaced first back-up rings 172; a spacer 174; a fuel side housing 176; a first ESD spacer 178; a screw housing 180; a mounting bolt housing 182; a plurality of screws 184; a plurality of locking bolt inserts or heli-coils 186; a second ESD spacer 188; a second O-ring 190; a third O-ring 192; a second back-up ring 194; an insulator housing 196; an insulator boot 198; a ring washer 200 with a plurality of apertures 201; an adapter 202; and a fourth O-ring 204. Specific structural details of the above-noted parts and their inter-fitting relationships are best seen in FIG. 17 and will be discussed in more detail hereinafter. In terms of the materials preferably utilized in the parts that make up fitting 150, air side housing 168, fuel side housing 176 and adapter 202 are preferably of a high strength light metal, such as titanium, GR 6AL-4V, annealed, AMS 4928; the pair of first O-rings 170 and fourth O-ring 204 are of ethylene propylene, NAS 1613, while second and third O-rings 190, 192 are of fluorosilicone, MIL-R-25988; the first pair of back-up rings 172 and second back-up ring 194 are of Teflon®, MIL-R-8791; first spacer ESD 187 and second spacer ESD are of Krefine (a peek base ESD material), EKH-SS07; screw housing 180, mounting bolt housing 182 are of Peek (poly-ether-ether-ketone), MIL-P-46183, type II, class 3; the plurality of screws 184 and the ring washer 200 are of CRES 15-5PH, AMS 5659, while the plurality of heli-coil inserts 186 are of stainless steel; insulator housing 196 is of carbon filled PTFE; and insulator boot 198 is of silicon, AFP 507. It should be understood that while the above-noted materials are the preferred materials, depending upon specific applications, other equivalent materials may also be utilized.

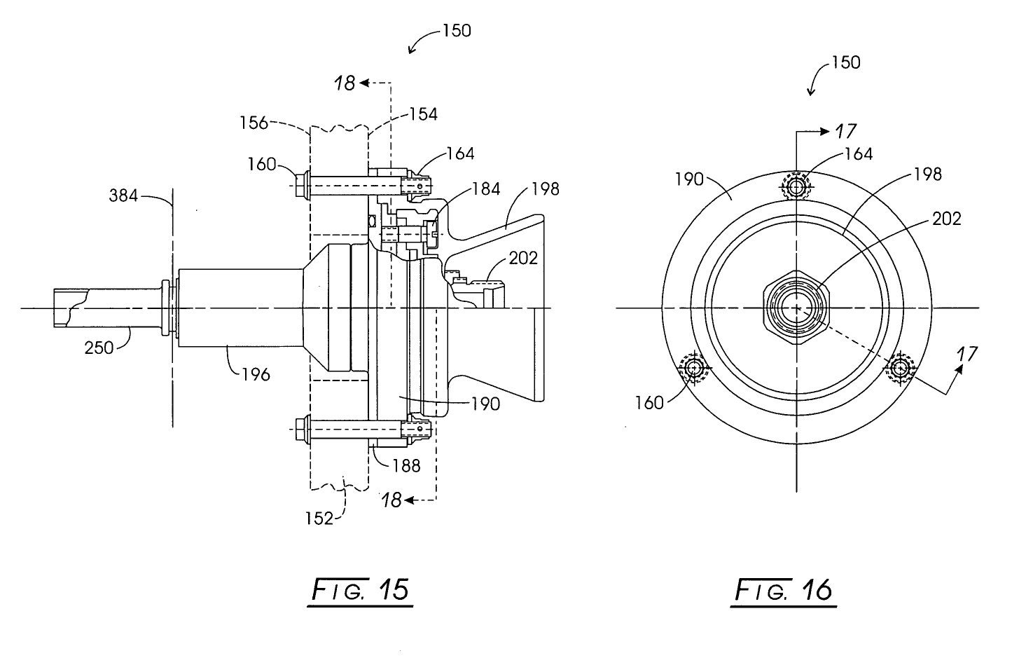

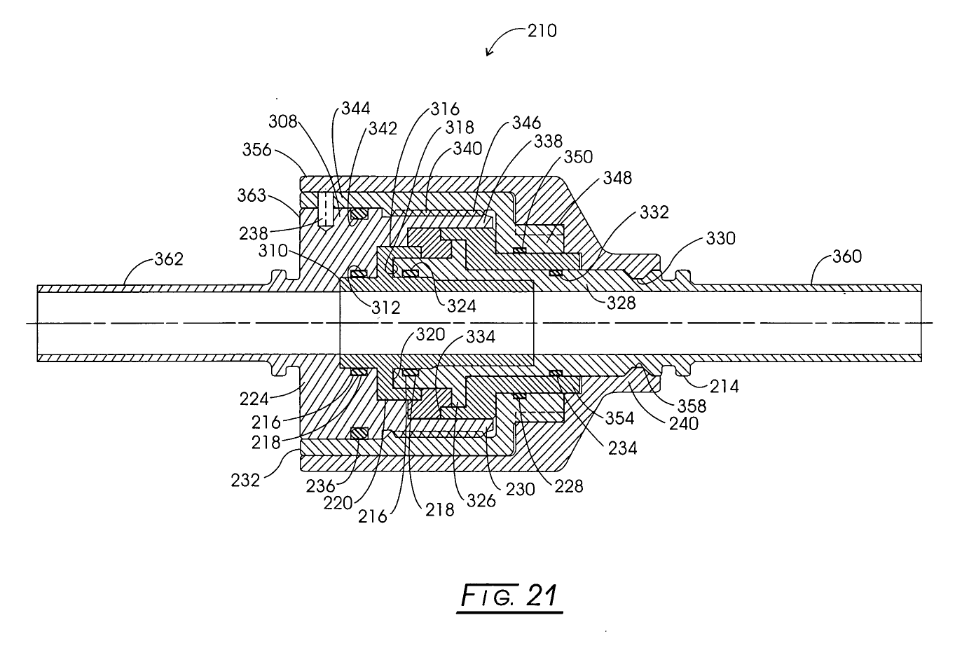

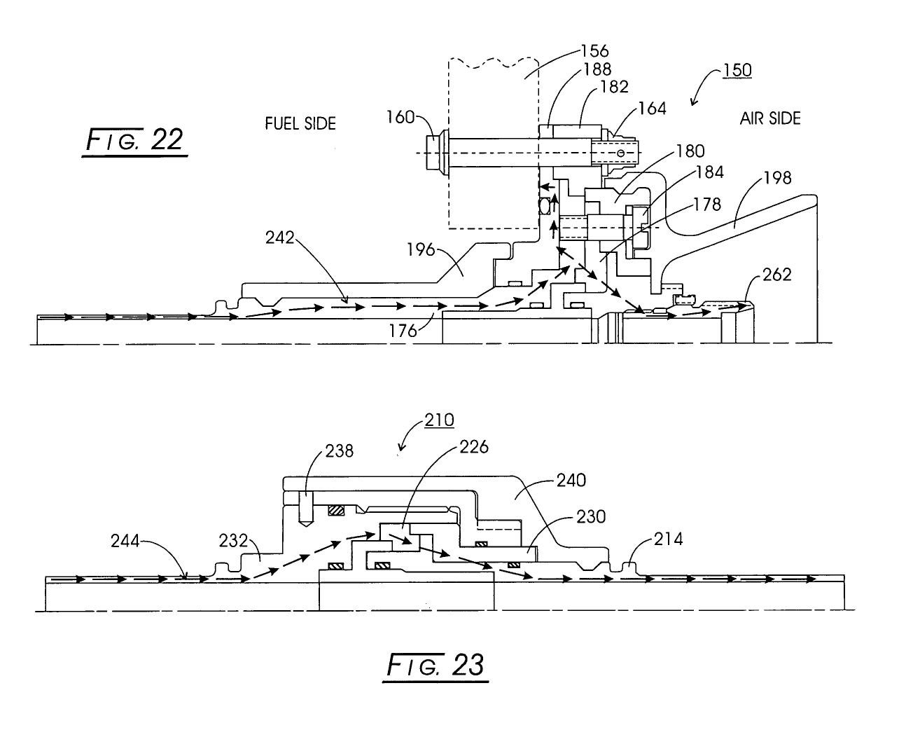

Proceeding now to yet another embodiment of this invention, illustrated in FIGS. 14, 19-21 and 23, is an in-line type dielectric fitting 210. As best seen in FIG. 21, fitting 210 basically includes a base housing 214; a pair of spaced first O-rings 216; a pair of spaced back-up rings 218; a first spacer 220; an inner housing 224; an ESD spacer 226; a second O-ring 228; a second spacer 230; an outer housing 232; a third O-ring 234; a fourth O-ring 236; a dowel pin 238; and an insulator housing 240. Specific structural details of the above-noted parts and their inter-fitting relationships will be discussed in more detail hereinafter. In terms of the materials preferably utilized in the parts that make up fitting 210, base housing 214, inner housing 224 and outer housing 232 are of either titanium, GR 6AL-4V annealed, AMS 4928 (high pressure applications) or of aluminum alloy 7075-T73, AMS-QQ-A-225/9 (low pressure applications); the pair of first O-rings 216 are of ethylene propylene, NAS 1613, while second, third and fourth O-rings 228, 234 and 236 are of fluorosilicone, MIL-R-25988; the pair of back-up rings 218 is of Teflon®, MIL-R-8791; ESD spacer 226 is of Krefine, EKH-SS07; first and second spacers 220 and 230 are of Peek, MIL-P-46183, type II, class 3; dowel pin 238 is of CRES, AMS 5735; and insulator housing 240 is of carbon filled PTFE. In addition, all previously noted aluminum parts are chemically coated, as per MIL-C-5541 class 3, to provide electrical conductivity and corrosion protection. Furthermore, all titanium parts are phosphate conversion coated, as per AMS 2486 to provide additional corrosion protection and electrical conductivity. Again, the above-noted materials are the preferred materials, but, depending upon specific applications, other equivalent materials may also be utilized.

Prior to explaining the detail functioning of bulkhead-type dielectric fittings 150 and 210′ as well as in-line type dielectric fitting 210, it should be understood that these fittings are also often referred-to as “static dissipative hydraulic isolators” and as “static dissipative fittings”. For ease of understanding and description, hereinafter, fittings 150 and 210′ will be referred to as “bulkhead design” which, while including FIGS. 13, 15-18, 21A and 22 will focus primarily on FIG. 17. Similarly, fitting 210 will be referred to as “in-line design”, which while including FIGS. 14, 19-21 and 23, will focus primarily on FIG. 21. For ease of understanding, the component parts of both the bulkhead design and the in-line design will be grouped into the following five functional groups:

Structural pressure vessels and system connection fitting components;

Linkage components;

Electrical insulating components;

Electrostatic components (including a thermal barrier for bulkhead design 150); and

Sealing components.

Starting with group 1, the structural pressure vessel components provide the frame and structure for each of bulkhead design 150 and in-line design 210. In terms of bulkhead design 150 (FIG. 17) the structural pressure vessel components comprise the interface connection to the system tubing (not shown) located on both the fuel side 156 and the air side 154 of the aircraft bulkhead. The system tubing is attached to the two static dissipative isolator housings, namely fuel side housing 176 and air side housing 168, preferably via threading. These two components provide a conduit that permits high pressure fluid to travel from the fuel side compartment to the air side compartment and vice versa, with air side housing 168 containing a cavity that houses adapter 202. In in-line design 210 (FIG. 21) the structural pressure vessel components also comprise the interface connection to the noted system tubing (not shown), with the system tubing being attached to the two static dissipative isolator housings, namely inner housing 224 and base housing 214, at extensions 362, 360, preferably via threading. Thus, these two housings provide a conduit for permitting pressurized fluid to travel from side to side.

Continuing with the group 2 linkage components, in bulkhead design 150, these components provide several functions, the first of which is to connect fuel side housing 176 and air side housing 168. This connection is preferably performed by a plurality of screws 184, a plurality of screw locking inserts, such as heli-coil inserts 186, screw housing 180 and ring washer 200. It should be understood that frangible screws can be used, but are utilized only in frangible static dissipative isolators. The second function is to support bulkhead mounting bolts 160 that secure bulkhead design 150 to bulkhead 152 using mounting bolt housing 182. These noted linking components also perform as a breakaway feature that will break at a lower force than that needed to break bulkhead mounting bolts 160 that secure bulkhead design 150 to the fuel tank (not shown). It should be understood that this feature is available only in frangible isolator designs. The frangible or bolt fracture screws will protect the tank by allowing the air side hydraulic isolator to rupture first. This allows the isolator to maintain the structural integrity of the fuel side, thus preventing the fuel tank from leaking. However, on non-frangible isolator designs, standard “non frangible” screws are utilized. The linking function of in-line design 210 is performed via outer housing 322 which is united with inner housing 224, preferably via threading. Outer housing 323 secures second spacer 230, which in turn supports base housing 214. The several parts are torqued together and then locked in place, such as for example, with captured dowel pin 238. Other methods of securing threaded parts include the use of adhesives, lockwires and swaging, etc, depending upon customer preference. Additionally, these linkage components are designed to sustain the required installation torque load, pressure impulse fatigue load, breakaway feature (if required) and tube-bending fatigue load.

Proceeding now to group 3, namely electrical insulating components, it is the function of these components to provide an electrical barrier between the bulkhead, fuel-side fitting and the air side fitting on bulkhead design 150, as well as the inner and outer fittings on in-line design 210. Specifically, in bulkhead design 150, spacer 174 provides a predetermined minimum, such as a 1.5 inch (3.81 cm.) linear electrical insulating distance on fluid side 156 that electrically isolates fuel side housing 176 from air side housing 168. Screw housing 180 also functions to isolate air side housing 168 from fuel side housing 176 while mounting bolt housing 182 electrically isolates fuel side housing 176 from the plurality of bulkhead mounting bolts 160 that attach isolator or bulkhead design 150 to aircraft bulkhead 152. Insulator jacket or boot 198 provides a predetermined minimum, such as a 3.0 inch (7.62 cm), surface length of linear insulating distance and a predetermined minimum, such as a 1.0 inch (2.54 cm.), line-of-sight insulating distance on the open-air area that prevents the air side fitting from creating an electrical path. Bulkhead housing insulator 196 prevents the electrical current from traveling between fuel side housing 176 and the aircraft bulkhead. Bulkhead housing insulator 196 has a conductivity of 10⁴ to 10⁸ ohms, and the resistance level prevents the static charge build up of this component immersed in fuel. It should be clear, as a result of viewing FIG. 17 that all these electrical insulating parts and their mating parts, are specifically designed in the illustrated zigzag manner, so as to increase the resistance created by the gaps. Additionally, further insulating coating is applied during installation in order to provide further electrical insulation properties. In the in-line design 210, first spacer 220 partially isolates one side from the other, with first spacer 220 providing a predetermined minimum, such as a 1.5 inch (2.54 cm.), electrical insulating space from inner housing 224 and base housing 214. Second spacer 230 also electrically isolates the two isolator ports. In addition, insulator jacket or housing 240 provides a predetermined minimum, such as a 3.0 inch (7.62 cm.), surface length of linear insulating distance and a further predetermined minimum, such as a 1.0 inch (2.54 cm.), line-of-sight insulating distance. The note actual values of such predetermined minimums of course vary, depending upon the specific physical sizes of the bulkhead type or in-line designs.

Moving now to the group 4, electrostatic components, it is the purpose of these components to control the electrical resistance (1×10⁴ to 1×10⁶ ohms) between air side housing 168, fuel side housing 176, and the aircraft bulkhead in bulkhead design 150 and between base housing 214 and inner housing 224 of in-line design 210. Specifically, in bulkhead design 150, two ESD spacers, specifically first ESD spacer 178 and second ESD spacer 188, provide this controlled electrical resistance. The static charge can be bled off the aircraft bulkhead, via second ESD spacer 188, to fuel side housing 176, and, via first ESD spacer 178, to air side housing 168. The static charges can also be bled off fuel side housing 176 through first ESD spacer 178 to air side housing 168 or vise versa. In bulkhead design 150, second ESD spacer 188 also serves to provide a thermal barrier between the higher hydraulic fluid temperature and the aircraft bulkhead. In the in-line design 210, a single ESD spacer 226 provides the controlled electrical resistance. The static charges can then be drained from inner housing 224 through ESD spacer 226 to base housing 214 or vice versa.

Turning now to group 5, sealing compounds, it is the purpose of these sealing compounds to provide a fluid barrier. In bulkhead design 150, the pair of spaced first O-rings 170 and pair of spaced first back-up rings 170 are used to seal the high-pressure fluid from fuel side housing 176 and air side housing 168. Second and third O-rings 190, 192 are also used to seal the fuel in the fuel tank from the aircraft to the air side. Fourth O-ring 204 is used to seal adapter 202. In the in-line design 210, the pair of first O-rings 216 and pair of first back-up rings 218 is used to seal the high-pressure fluid from inner housing 224. Second, third and fourth O-rings 228, 234 and 236, are also used to seal the fuel in the fuel tank from possible contact with the ethylene propylene seals, namely the pair of first O-rings 216. If the in-line design 210 passes through a non-fluid-filled cavity, the three O-rings 228, 234 and 236 may be removed and replaced with an appropriate sealant.

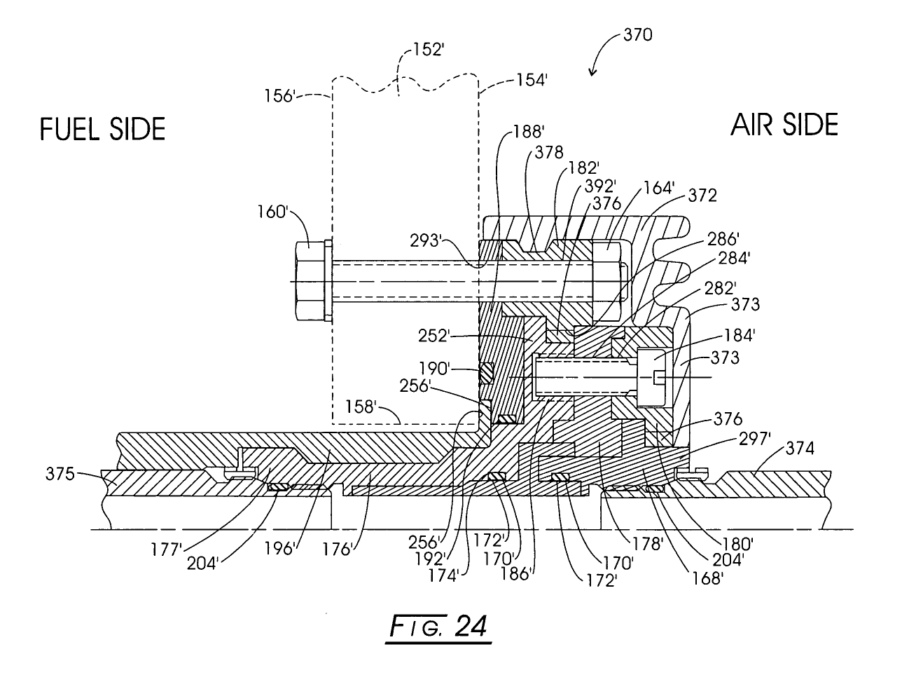

The electrical resistance of the several ESD spacers, namely first and second ESD spacers 178, 188 of bulkhead design 150 and ESD spacer 226 of in-line design 210, is a function of many variables, including grain orientation and surface contamination. The controlled resistance electrical path 242 and 244 for bulkhead design 150 and in-line design 210, respectively, is shown by the arrow paths 242 and 244 in FIGS. 22 and 23. In some bulkhead applications screws 184 can take the form of screws which are designed to provide a breakaway feature that protects the fuel tank in the event of a malfunction. For such specific applications, the air side housing 168 is supported with frangible or break-away bolts 184 that will break or fracture at a lower force than the bulkhead mounting screws 160 that secure bulkhead design 150 to the fuel tank. These special bolts 184 will protect the fuel tank by allowing the hydraulic structure to rupture while maintaining the structural rigidity of the fuel side, thus preventing the fuel tank from leaking. The frangible screw design is based on a proven screw design used on the Stratoflex Fuel Breakaway Valves (catalog 106-CFBV, August 1999), marketed by the Parker Hannifin Corporation of Cleveland, Ohio, the assignee of the present invention.

In bulkhead design 150, spacer 174 and, in inline design, spacers 220 and 230 serve two main functions, with the first function being the providing of electrical insulation, while the second function is to carry the structural load due to pressure and vibration. The preferred Peek (Polyetherketone) material maintains the creep stress levels at a low value that ensures that the design meets four times the service life requirement. The ESD spacer parts 178, 188 and 226 provide the control resistance that permits the discharge of static electricity. In bulkhead design 150, the ESD spacer part 188 also provides a thermal barrier that limits bulkhead temperature to a predetermined value. While the preferred ESD material is Krefine EKH-SS07, a Peek-based ESD material, other grades of this material or compatible materials may be used to provide different electrical characteristics or to reduce product cost for less severe structural applications.

Returning now to FIG. 17, bulkhead-type fitting 150 is illustrated as being mounted on a vessel bulkhead 152 via a plurality of customer-supplied bulkhead mounting bolts 160 cooperating with corresponding washers 162 and self-locking nuts 164. Generally tubular fuel side housing 176, which extends principally into fuel side 156, includes an axial inner extension 250 and a multi-level annular flange portion 252 extending through bulkhead aperture 158, with flange portion 252 including a radial internal cavity 253 that houses first ones of the pair of O-rings 170 and backup rings 172 which serve to seal against a peripheral surface portion of spacer 174. Surrounding and coupled to a major axial portion of fuel side housing 176, via a complementary tongue and groove arrangement 255 on one end thereof, is insulator housing 196, whose other end includes an offset annular flange portion 254 that, in turn, is coupled with an annular multiple flange portion 256 of generally disc-shaped second ESD spacer 188. Second ESD spacer 188 includes a radial inner cavity 257 that houses third O-ring 190 and second back-up ring 194 that together serve to seal an outer surface portion of fuel side housing 176. Second ESD spacer 188 further includes a peripheral groove 258 that houses second O-ring 190 which serves to seal second ESD spacer 188 relative to bulkhead air side 154. Coaxial with fuel side housing 176 and secured within its flange portion 252 is a tubular portion of spacer 174 which also includes an annular peripheral portion 260 that defines a peripheral cavity 262. Extending into cavity 262 is an inner end portion 266 of generally tubular air side housing 168, with portion 266 including a radial cavity or groove 268 that houses second ones of the pair of O-rings 170 and back-up rings 172, which here serve to seal against another peripheral surface portion of spacer 174. Air side housing 168 further includes a multi-stepped axial portion 270 that mates with a corresponding inner side of a Z-shaped (in section) portion 272 of generally annular screw housing 180.

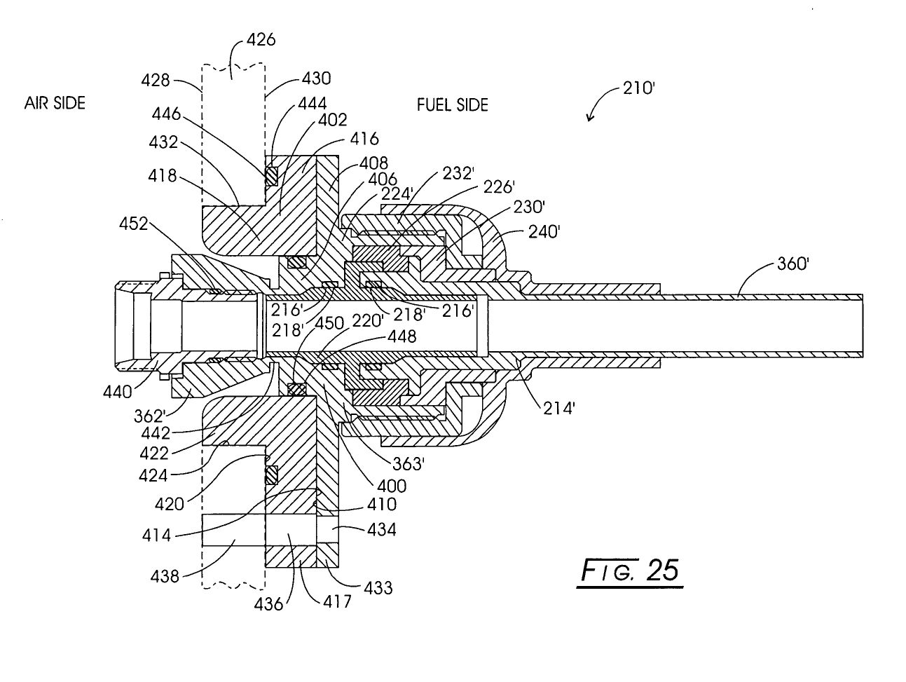

Screw housing 180 has an annular peripheral front cavity 280 which, in turn, has a plurality of preferably equally spaced axial apertures 282 which are coaxial with corresponding pluralities of such apertures 284 and 286 in first ESD spacer 178 and flange portion 252 of fuel side housing 176, respectively. Each of apertures 286 is provided with a screw retention insert 186, such as a heli-coil. The plurality of screws 184, extending through apertures 201 of supporting ring washer 200, serves to unite fuel side housing 176 with first ESD spacer 178, air side housing 168 and screw housing 180. Generally ring-shaped mounting bolt housing 182 includes an inner, stepped, peripheral surface 290 that mates with corresponding stepped surfaces of second ESD spacer 188, fuel side housing flange portion 252, first ESD spacer 178 and screw housing 180, the latter confining mounting bolt housing 182 against axial movement. The plurality of bulkhead mounting bolts 160 extends through corresponding axial apertures 292 and 293 in mounting bolt housing 182 and second ESD spacer 188, respectively. Air side housing 168 includes a central through bore 294 coaxial with the through bores of spacer 174 and fuel side housing 176. Bore 294 includes a recess or groove 296 that houses fourth O-ring 204 which, in turn, serves to seal adapter 202, threadably received within bore 294, relative to an inlet portion of air side housing 168. A peripheral groove 298, in screw housing 180, cooperates with a mating peripheral boss 300 of insulator boot or jacket 198 having a base portion or outer end surface 199, and in conjunction with a boot rib 302, extending into a screw housing cavity 180, and a boot ring 304, extending into a recess 306 in air side housing 168, combines to fixedly secure insulator boot 198 to the noted adjoining structures. Jacket 198 also includes a generally tapered or outwardly-extending conically flared or tapered portion 288. It should be understood that insulator jacket 198 can also be constructed so as to have a flush arrangement with bulkhead 152 (similar to insulator jacket 372 shown in FIG. 24) as long as the minimum external electrical path lengths are maintained to the desired levels to provide insulation.

As best illustrated in FIG. 17, the structure of bulkhead-type fitting 150 also includes a first or external transverse fracture plane 380 that is axially or longitudinally outwardly spaced a predetermined distance from air side 154 of bulkhead 152. First fracture plane 380 essentially passes through the threaded portion of frangible screws 184; adjoining screw locking inserts 186 in air side housing 176. This external breakaway feature, on the air side of bulkhead 152, protects the fuel tank (not shown) by allowing the air side hydraulic isolator to rupture first. In addition, axial extension 250 of fuel side housing outlet portion 177, at an inwardly spaced predetermined distance from fuel side 156 of bulkhead 152, includes a peripheral notched groove 251 which serves to provide a controlled weak area. A second or inner fracture plane 384 passes through groove 251 and provides an internal breakaway feature on the fuel side of bulkhead 152 when it is desired to have a controlled break feature within the fuel tank.

Continuing with FIG. 21, in in-line fitting 210, generally tubular inner housing 224 includes a multi-level annular flange portion 308 having an inner, stepped, recessed portion 310, with a peripheral groove or cavity 312 that houses first ones of the pair of first O-rings 216 and backup rings 218 which serve to seal against an outer peripheral surface portion of first spacer 220. Coaxial with inner housing 224 and secured within stepped, recessed portion 310 thereof, is a tubular portion of first spacer 220 which also includes an annular peripheral portion 316 that defines a peripheral cavity 318. Extending into cavity 318 is an annular inner end portion 320 of base housing 214, with end portion 320 including a peripheral groove 324 that houses the second ones of the first pair of O-rings 216 and back-up rings 216 which serve to seal against another outer peripheral surface portion of first spacer 220. Base housing 214 also includes a peripheral flange portion 326, with generally offset ring shaped ESD spacer 226 being interposed between the end of first spacer peripheral portion 316 and one side of flange portion 326 of base housing 214. A cylindrical central portion 328 of base housing 214 includes a recess or groove portion 330 and a recessed groove 332 that houses second O-ring 228 that serves to seal an adjacent inner peripheral surface portion of offset, generally cylindrical second spacer 230. An annular inner end surface 334 of second spacer 230 abuts an offset portion of ESD spacer 226. The peripheral outer surface of second spacer 230 and ESD spacer 226 are received within a cavity 338 in inner housing flange portion 308. The outer peripheral surface of flange portion 308 includes a threaded portion 340 as well as a peripheral cavity or groove 342 that houses fourth O-ring 236 which serves to seal against the inner peripheral surface of the large diameter portion 344 of outer housing 232.

Outer housing large diameter portion 344 includes an internally threaded surface portion 346 that mates with threaded portion 340. A small diameter portion 348 of outer housing 232 includes an inner peripheral groove 350 that houses third O-ring 234 which serves to seal against the outer peripheral surface of small diameter portion 354 of second spacer 230. Surrounding and enveloping most of the previously-described components of in-line design 210 is generally cup-shaped insulator housing 240 whose large diameter outer portion 356 surrounds outer housing large diameter portion 344 and tapers, on one end, down to a lip portion 358 that mates with base housing groove portion 230 so as to secure insulator housing 240 against axial movement. Axial extension 360 of base housing 224 and axial extension 362 of inner housing 224 are coaxial and extend from opposite ends of in-line design 210.

Turning to FIG. 24, illustrated therein is a sixth embodiment of this invention, namely another bulkhead-type dielectric fitting 370 which is a similarly mounted, slightly different version of bulkhead design 150, best shown in FIG. 17. For ease of understanding as well as brevity, like numerals, with the addition of a prime suffix (′), are applied to like parts. Specifically, bulkhead design 370 is also secured to a bulkhead or mounting 152′, having an air side 154′ and a fuel side 156′, with a plurality of preferably evenly peripherally spaced self-sealing mounting bolts 160′ and lock nuts 164′. Fitting 370 basically includes an air side housing 168′; a pair of spaced first O-rings 170′; a pair of spaced first backup rings 172′; a spacer 174′; a fuel side housing 176′; a first ESD spacer 178′; a screw housing 180′; a mounting bolt housing 182′; a plurality of frangible screws 184′; a plurality of locking screw inserts 186′; a second ESD spacer 188′; a second O-ring 190′; a third O-ring 192′; a pair of spaced fourth O-rings 204′; an insulator housing 196′; an insulator boot or jacket 372; an outer or air side union 374; and an inner or fuel side union 375. In terms of the materials utilized in the above-described parts, they are substantially similar to their like parts in fitting 150. Other, equivalent, materials can also be utilized.

The function of the component parts of bulkhead design 370 is substantially similar to that pertaining to the like parts of bulkhead design 150 and thus, in the interest of brevity, will not be repeated here. The main differences between designs 150 and 370 include the latter's use of insulator boot or jacket 372 that is generally cup-shaped and has a tongue and groove retention fit 378 relative to mounting bolt housing 182′, as well as having an annular outer end face 373 that covers the outer end faces of mounting bolt and screw housings 182′, 180′, respectively. In addition, instead of adapter 202 and the axial extension 250 of fuel side housing 176 (all in FIG. 17), bulkhead design 370 utilizes a generally cylindrical customer-supplied union 374, preferably made of a titanium alloy material, at both axial ends thereof. In addition, air side housing 168′, screw housing 180′, fuel side housing 176′ and mounting bolt housing 182′ include intermeshing, matching teeth 376 that serve to transmit installation torques from the air side fitting and the fuel side fitting to the bulkhead. Thus, teeth 376 and frangible screws 184′ transfer the load to bulkhead 152′ and mounting bolts 160′.

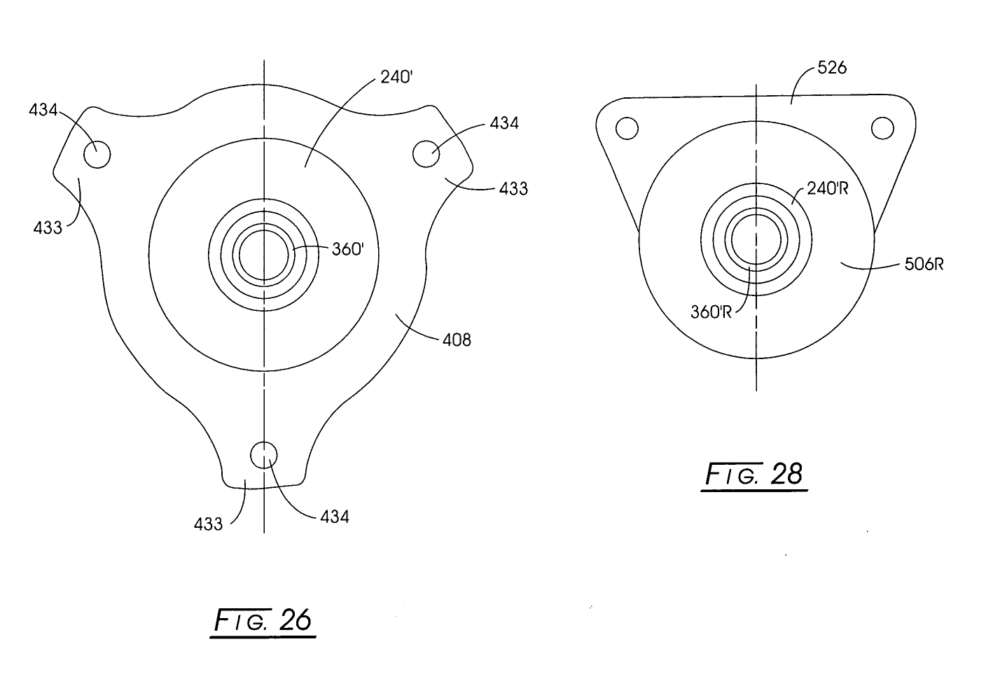

Proceeding now to FIGS. 25 and 26, illustrated therein is still a further embodiment of the present invention, namely a bulkhead-type variation 210′ of previously-discussed inline type dielectric fitting 210, best shown in FIG. 21. For ease of understanding as well as brevity and simplicity, like numerals, with the addition of a prime (′) suffix, are applied to like parts. Basically, inline type fitting 210 is modified so as to produce a bulkhead-type fitting 210′ by the addition of an axial extension member 400 and an insulator member 404. Specifically, axial extension member 400, having a hub portion 406 and a generally disc-shaped portion 408 is added to one end 363′ of generally tubular inner housing 224′, at about its juncture with axial extension 362. Interposed between an annular inner end surface 410, of disc-shaped portion 408 is an adjoining first annular end portion 414 of insulator member 402, also having a ring portion 416, a central hub portion 418, a second annular end surface 420 and a third annular end surface 422, with surfaces 420 and 422 being joined via an interposed peripheral step portion 424. As set forth in FIG. 25, insulator member 402, preferably comprised of a Peek-type composition material, is interposed between extension member disc and hub portions 408, 406, respectively, and a vessel bulkhead 426 having an air side 428 and a fuel side 430, with insulating member step portion 424 abutting a bulkhead aperture 432 and bulkhead fuel side 430. Extension member disc portion 408 is provided with a plurality of preferably equally peripherally spaced radially outwardly-directed flange portions 433, best seen in FIG. 26, with each flange portion 433 being provided with an axial aperture 434. Insulator member ring portion 416 is also provided with a plurality of equally peripherally-spaced flange portions 417, each having an axial aperture 436 which is coaxial with a corresponding aperture 434 and a further corresponding one of apertures 438 in bulkhead 426. Each of the noted corresponding apertures 434, 436 and 438 is provided for mounting bulkhead type dielectric fitting 210′ on bulkhead 426. Generally tubular axial extension 362′ extends through bulkhead aperture 432 and is provided with an air side tubular union 440, conforming to an AS-5550 standard.

Furthermore, tubular extension 362′, in the vicinity of hub portion 406, is provided with a peripheral groove 442 which serves as a controlled weak area that functions as an external breakaway, if necessary. Insulator member 402 is in a sealing relationship with bulkhead fuel side 430 via a sealing member 444, such as an O-ring, of a preferably fluorosilicone composition material, received within recess 446 in insulator member ring portion 416. In addition, insulator member tubular hub 418 is in a sealing relationship with extension member hub portion 406 via a sealing member 448, such as an O-ring, of a preferably fluorosilicone composition material, received within a recess 450 in hub portion 406. Finally, tubular union 440 is in a sealing relationship with tubular extension 362′ via an interposed seal member 452, such as an O-ring, of a preferably ethylene propylene composition material.

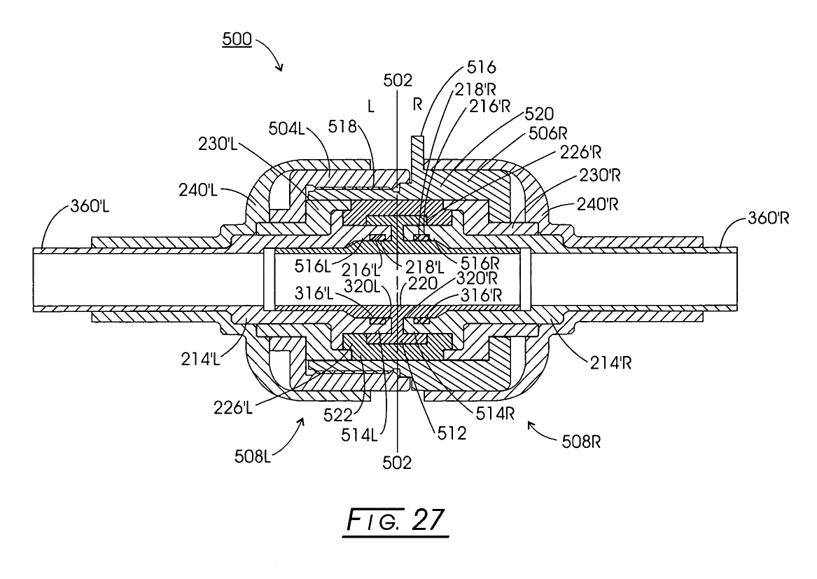

Turning now to FIGS. 27 and 28, illustrated therein is a yet differing embodiment of this invention, namely an inline type dielectric fitting 500 which is basically another modification of previously discussed inline fitting 310, best shown in FIG. 17. Again, for ease of understanding, brevity and simplicity, like numerals with the addition of a prime (′) suffix, are applied to like parts. Basically, inline fitting 500, except for left or first outer housing 504L and for right or second outer housing 506R, is comprised of first or left portion 508L and second or right portion 508R, located on opposed sides of a bisecting central plane 502, perpendicular to the axial extent of dielectric fitting 500, with further suffixes “L” and “R” being utilized to identify the location of the same but oppositely directed allochiral or mirror-image parts. Thus, a stepped, symmetrical, generally tubular, central, first spacer 220′, includes opposed peripheral rim portions 316′L, 316′R, separated via a center rib portion 512. Sealingly extending into annular spaces 514L and 514R, between center rib portion 512 and rim portions 316′L and 316′R, are the opposed end portions 320′L and 320′R of a pair of coaxial, oppositely-directed, stepped, tubular first or inner housings 214′L and 214′R, respectively. Each end portion 320′L and 320′R includes a respective recess 516L and 516R, which respectively serve to house one of a pair of first sealing elements 216′L, 216′R, such as O-rings, and adjoining corresponding one of a pair of backup rings 218′L, 218′R.

A pair of coaxial, oppositely-directed, stepped, generally tubular second spacers 230′L and 230′R respectively serve to radially and axially separate the pair of inner housings 214′L and 214′R from left outer housing 504L and right outer housing 506R. Specifically, outer housing 504L includes an internally threaded annular flange portion 518 that mates with an externally threaded, reduced diameter, axial extension 522 of large outer diameter main portion 520 of outer housing 506R, so as to secure outer housings 504L and 506R against relative rotation therebetween. Spacer 226′L of a pair of coaxial, oppositely-directed, stepped, generally cylindrical electrical dielectric discharge spacers 226′L and 226′R, is interposed between and separates inner housing 214′L from axial extension 522 of outer housing 506R, while spacer 226′R is interposed between and separates inner housing 214′R from main portion 520 of outer housing 506R. Dielectric discharge spacers 226′L and 226′R also serve to radially separate first spacer 220 from main portion 520 of outer housing 506R and its axial extension 522. One of a pair of coaxial, oppositely-directed, generally cup-shaped insulator housings 240′L envelops and surrounds inner housing 214′L and outer housing 504L, while the other one of this pair of insulator housing, namely 240′R, envelops and surrounds inner housing 214′R and outer housing 506R.

As also shown in FIG. 27, but best seen in FIG. 28, at about the junction of large diameter portion 520, of outer housing 506R, and its adjoining, axially-extending intermediate outer diameter portion 522, housing 506R is provided with a radially outwardly directed flange portion 526 that includes a pair of spaced, axially directed through apertures 528 that serve for mounting purposes, if so required. Axially extending portions 360′R and 360′L, of housings 214′R and 214′L serve as fluid inlet/outlet portions, depending upon the direction of fluid flow.

It should be understood that the basic design philosophies previously expressed, in terms of the five noted functional groups, relative to bulkhead design 150 (FIG. 17) and inline design 210 (FIG. 21) are also applicable to other versions thereof, as described herein.

Some of the advantages of the several embodiments of this invention, namely fittings 30, 30′, 150, 210, 210′, 370 and 500 of this invention include availability for tube sizes typically ranging at least from 0.250 to 1.50 inches (0.635 to 3.81 cms.) in diameter and operating pressures of up to 5000 psi. As illustrated, these fittings may be of the bulkhead or inline type design and contain no weld joints. The operating temperature range extends from at least −65 degrees F. to 275 degrees F. These fittings provide a minimum of 1×10⁵ ohms of electrical resistance, with this resistance being provided for both tube to tube and mounting flange to tube. At least one of the embodiments of this invention provides a built-in anti-rotation feature to sustain larger tubing end or end fitting installation torque. These fittings also utilize one-piece housings that merge into the fuel tanks, thereby eliminating any leak paths from the high pressure lines to the fuel tanks, except for the end fitting connection. Furthermore, one-piece housings are utilized in the fuel sides to minimize bulkhead penetration (installation) apertures. The noted designs, if so required, can provide a breakaway feature that protects the fuel tank in the event of a malfunction. Specifically, the housing fitting, located in the air side, is supported with frangible bolts that will break at a lower force than the bulkhead mounting screws that secure the dielectric fitting to the fuel tank. These frangible screws will protect the fuel tank by allowing the hydraulic to rupture while maintaining the structural integrity of the fuel side, thus preventing the fuel tank from leaking. Finally, these designs can support a ring-locked fluid connection as per AS 1300 or the like.

It is deemed that one of ordinary skill in the art will readily recognize that the several embodiments of the present invention fill remaining needs in this art and will be able to affect various changes, substitutions of equivalents and various other aspects of the invention as described herein. Thus, it is intended that the protection granted hereon be limited only by the scope of the appended claims and their equivalents.

What is claimed is:

1. An in-line type dielectric tubular fitting for dissipating the electric energy from static charges and controlling large current flows, caused at least in part by fluid movements and the indirect effects of lightning, in case of such an occurrence, as well as providing a safe passage of high pressure fluids therethrough, said fitting comprising in combination:
a. a stepped, generally tubular base housing;
b. a stepped, generally tubular inner housing, coaxial with said base housing;
c. a stepped, generally tubular outer housing, coaxial with said inner housing, peripherally, sealingly, surrounding said inner housing, and securing same against rotation relative to said inner housing;
d. a stepped, generally tubular first spacer sealingly interposed between as well as both axially and radially separating said inner and base housings;
e. a stepped, generally tubular second spacer sealingly interposed between said base, inner and outer housings, and both axially and radially separating at least said base and outer housings;
f. a stepped, generally cylindrical electrostatic discharge spacer interposed between and both axially and radially separating at least said base and inner housings, as well as separating said first and second spacers; and
g. a generally cup-shaped insulator housing, affixed to said base housing, enveloping said base, inner and outer housings.

2. The in-line dielectric tubular fitting of claim 1, further including a pair of spaced first sealing elements and an adjoining, corresponding, pair of spaced first backup rings, interposed between spaced portions of said first spacer and opposed such portions of said outer housing and said base housing, respectively.

3. The in-line dielectric tubular fitting of claim 2, wherein said pair of spaced first sealing elements takes the form of O-rings comprised of an ethylene propylene type material composition; and said pair of first backup rings is comprised of a PTE type material composition.

4. The in-line dielectric tubular fitting of claim 1, further including:
a. a second sealing element interposed between said second spacer and an opposed portion of said outer housing;
b. a third sealing element interposed between said second spacer and an opposed portion of said base housing; and
c. a fourth sealing element interposed between said inner housing and an opposed portion of said outer housing.

5. The in-line dielectric tubular fitting of claim 4, wherein said second, third and fourth sealing elements take the form of an O-ring comprised of a fluorosilicone type material composition.

6. The in-line dielectric tubular fitting of claim 1, wherein said base, inner and outer housings each are comprised of one of a titanium alloy material and an aluminum alloy material composition.

7. The in-line dielectric tubular fitting of claim 6, wherein said titanium alloy material is of an AL-4V composition and said aluminum alloy material is of a 7075-T73 composition.

8. The in-line dielectric tubular fitting of claim 1, wherein said tubular first and second spacers each are comprised of a Peek material composition.

9. The in-line dielectric tubular fitting of claim 1, wherein said tubular first spacer provides a predetermined minimum electrical insulating space from said inner and base housings.

10. The in-line dielectric tubular fitting of claim 9, wherein said minimum electrical insulating space is at least 3.81 cm.

11. The in-line dielectric tubular fitting of claim 1, wherein said electrostatic discharge spacer is comprised of a Krefine material composition.

12. The in-line dielectric tubular fitting of claim 1, wherein said insulator housing is comprised of a carbon filled PTFE type material composition.

13. The in-line dielectric tubular fitting of claim 1, wherein said outer housing is secured to said inner housing via intermeshing threads and secured against rotation via a dowel pin.

14. The in-line dielectric tubular fitting of claim 1, wherein said tubular base housing includes an axially extending inlet portion on one end thereof.

15. The in-line dielectric tubular fitting of claim 1, wherein said tubular inner housing includes an axially extending outlet portion on one end thereof.

16. The in-line dielectric tubular fitting of claim 1, wherein the electrical resistance, ranging from 1×10⁴ to 1×10⁶ ohms, between said base housing and said inner housing, is controlled via said electrostatic discharge spacer.

17. The in-line dielectric tubular fitting of claim 16, wherein the path of said controlled electrical resistance proceeds axially outwardly from said inner housing to said base housing via said interposed electrostatic discharge spacer and vise versa.

18. The in-line dielectric tubular fitting of claim 1, wherein said insulator housing provides a predetermined first minimum surface length of linear insulating distance and a predetermined second minimum line-of-sight distance insulating distance.

19. The in-line dielectric tubular fitting of claim 18, wherein said first and second insulating distances are at least 7.62 cm. and 2.54 cm., respectively.

20. In the in-line dielectric tubular fitting of claim 1, wherein said generally tubular inner housing further includes an axial extension member on one end thereof, said extension member including a hub portion and a coaxial generally disc-shaped portion, located intermediate said extension member and said one end of said inner housing.

21. The in-line dielectric tubular fitting of claim 20, wherein said one end of said tubular inner housing, at said extension member, includes a peripheral controlled weak portion.

22. The inline dielectric tubular fitting of claim 20, further including an insulator member having a central tubular hub, coaxial with said extension member, and a ring portion having a first annular end surface abutting a corresponding annular end surface of said disc-shaped portion of said extension member, with the addition of said disc-shaped portion and said insulator member modifying the construction of said in-line type dielectric fitting to that of a bulkhead type dielectric fitting adapted to at least partially axially extend through an aperture in the bulkhead of a vessel.

23. The bulkhead-type dielectric fitting of claim 22, wherein said ring portion has a second annular end surface abutting a corresponding annular end surface of said bulkhead and said disc-shaped portion has a plurality of peripherally-spaced, radially outwardly directed first flange portions, with each of said first flange portions having a first aperture and said ring portion having a plurality of peripherally-spaced, radially outwardly-directed second flange portions, with each of said second flange portions having a second aperture, said first and second apertures being coaxial and serving for mounting purposes.

24. The bulkhead-type dielectric fitting of claim 22, wherein said one end of said tubular inner housing includes, at said extension member, a peripheral controlled weak portion.

25. A bulkhead-type dielectric tubular fitting, extending through an aperture in the bulkhead of a vessel, for dissipating the electric energy from static charges and controlling large current flows caused by at least in part by fluid movements and the indirect effects of lightning, in case of such an occurrence, as well as providing safe passage of high pressure fluids therethrough, said fitting comprising in combination:
a. a stepped, generally tubular, inner housing, having an outlet portion on one end thereof;
b. a stepped, generally tubular, outer housing, coaxial with said inner housing;
c. a stepped, generally tubular, spacer sealingly interposed between and both axially and radially separating said inner and outer housings;
d. a stepped, generally disc-shaped, first electrostatic discharge spacer interposed between and both axially and radially separating at least said inner and outer housings;
e. a stepped, generally disc-shaped second electrostatic discharge spacer sealingly interposed between said inner housing and an adjoining side of said bulkhead;
f. a generally tubular insulator housing, affixed to said inner housing, enveloping a cylindrical portion of said inner housing and abutting an annular end portion of said second electrostatic discharge spacer;
g. a generally ring-shaped mounting bolt housing, abutting adjoining portions of said inner housing and said second electrostatic discharge spacer, having a spaced plurality of axial mounting bolt apertures axially and rotationally aligned with a corresponding such mounting bolt aperture in said second electrostatic discharge spacer;
h. a generally ring-shaped screw housing, abutting adjoining portions of said outer housing and said first electrostatic discharge spacer, having a spaced plurality of screw apertures axially and rotationally aligned with corresponding such screw apertures in said first electrostatic discharge spacer and a disc-shaped portion of said inner housing;
i. a plurality of screws, each screw extending through one of said screw apertures and corresponding screw apertures for secured engagement with a corresponding one of a plurality of screw retention inserts located in said corresponding screw apertures in said inner housing disc-shaped portion;
j. a ring washer having a plurality of apertures, corresponding with said screw apertures, interposed between said plurality of screws and an adjoining side of said screw housing;
k. a tubular adaptor, coaxial with and sealingly attached to an inlet portion of said tubular outer housing; and
l. a generally cup-shaped insulator boot having a base portion, attached at least to said screw housing, and an outwardly flared portion surrounding at least said adaptor.

26. The bulkhead-type dielectric tubular fitting of claim 25, further including a pair of spaced first sealing elements and an adjoining, corresponding, pair of first backup rings, interposed between separated portions of said tubular spacer and opposed such portions of said outer housing and said inner housing, respectively.

27. The bulkhead-type dielectric tubular fitting of claim 26, wherein said pair of spaced first sealing elements takes the form of O-rings comprised of an ethylene propylene type material composition; and said pair of first backup rings is comprised of a PTFE type material composition.

28. The bulkhead-type dielectric tubular fitting of claim 25, further including:
a. a second sealing element interposed between said second electrostatic discharge spacer and an adjoining outer surface of said bulkhead;
b. a third sealing element and an adjoining second backup ring interposed between said second electrostatic discharge spacer and an opposed portion of said inner housing; and
c. a fourth sealing element interposed between said outer housing and an opposed portion of said tubular adaptor.

29. The bulkhead-type dielectric tubular fitting of claim 28, wherein said second, third and fourth sealing elements each takes the form of an O-ring comprised of a fluorosilicone type material composition.

30. The bulkhead-type dielectric tubular fitting of claim 25, wherein said tubular adaptor as well as said inner and outer housings are comprised of one of a titanium alloy material composition and an aluminum alloy material composition.

31. The bulkhead-type dielectric tubular fitting of claim 25, wherein said tubular spacer as well as said mounting bolt housing and said screw housing are comprised of a Peek material composition.

32. The bulkhead-type dielectric tubular fitting of claim 25, wherein said first and second electrostatic discharge spacers are comprised of a Krefine material composition.

33. The bulkhead-type dielectric tubular fitting of claim 25, wherein said insulator housing is comprised of a carbon filled PTFE type material composition.

34. The bulkhead-type dielectric tubular fitting of claim 25, wherein said tubular inner housing includes an axially extending outlet portion on one end thereof.

35. The bulkhead-type dielectric tubular fitting of claim 34, wherein said outlet portion includes at a predetermined axial distance from said bulkhead, a peripheral controlled weak portion.

36. The bulkhead-type dielectric tubular fitting of claim 35 further including an internal fracture plane passing perpendicularly through said controlled weak portion, thereby providing a controlled inner breakaway feature.

37. The bulkhead-type dielectric tubular fitting of claim 25, wherein the control of the electrical resistance, ranging from 1×10⁴ to 1×10⁶ ohms, between said outer housing and said inner housing is controlled via said first and second electrostatic discharge spacers.

38. The bulkhead-type dielectric tubular fitting of claim 37, wherein the path of said controlled electrical resistance proceeds from said bulkhead, via said second electrostatic discharge spacer, to said inner housing and, via said first electrostatic discharge spacer, to said outer housing, and from said inner housing, through said first electrostatic discharge spacer, to said outer housing and vice versa.

39. The bulkhead-type dielectric tubular fitting of claim 37, wherein said second electrostatic discharge spacer also serves as a thermal barrier between a higher temperature fluid, passing through said tubular fitting, and said bulkhead.

40. The bulkhead-type dielectric tubular fitting of claim 25, wherein said plurality of screws and said ring washer are comprised of a CRES 15-5PH material composition and said plurality of screw retention inserts is comprised of a stainless steel alloy material.

41. The bulkhead-type dielectric tubular fitting of claim 40, wherein said screws are frangible screws.

42. The bulkhead-type dielectric tubular fitting of claim 41, further including an external fracture plane, axially outwardly at a predetermined distance from said bulkhead, thereby providing a controlled external breakaway feature.

43. The bulkhead-type dielectric tubular fitting of claim 42, wherein said external fracture plane essentially passes through the threaded portion of said frangible screws, adjoining said locking screw inserts in said inner housing.

44. The bulkhead-type dielectric tubular fitting of claim 25, wherein said insulator boot is comprised of a silicon type material composition.

45. The bulkhead-type dielectric tubular fitting of claim 25, wherein said tubular spacer provides a predetermined minimum electrical insulating space, on the inner side of said bulkhead, that electrically isolates said inner housing from said outer housing.

46. The bulkhead-type dielectric tubular fitting of claim 45, wherein said minimum electrical insulating space is at least 3.81 cm.

47. The bulkhead-type dielectric tubular fitting of claim 25, wherein said insulator boot provides a predetermined first minimum surface length of linear insulating space and a predetermined second minimum line-of-sight insulating distance, on the outer side of said bulkhead, that prevents the portion of said fitting, on the outside of said bulkhead, form from creating an electrical path.

48. The bulkhead-type dielectric tubular fitting of claim 47, wherein said first and second insulating distances are at least 7.62 and 2.54 cm., respectively.

49. A bulkhead-type dielectric fitting, extending through an aperture in the bulkhead of a vessel, for dissipating the electrical energy from static charges and controlling large current flows, caused by at least in part by fluid movements and the indirect effects of lightning, in case of such an occurrence, as well as providing a safe passage of high pressure fluids therethrough, said fitting comprising in combination:
a. a stepped, generally tubular, inner housing;
b. a stepped, generally tubular, outer housing, coaxial with said inner housing;
c. a stepped, generally tubular, spacer sealingly interposed between and both axially and radially separating said inner and outer housings;
d. a stepped, generally disc-shaped, first electrostatic discharge spacer interposed between and both axially and radially separating at least said inner and outer housings;
e. a stepped, generally disc-shaped second electrostatic discharge spacer sealingly interposed between said inner housing and an adjoining side of said bulkhead;
f. a generally tubular insulator housing, affixed to said inner housing, enveloping a cylindrical portion of said inner housing, and abutting an annular end portion of said second electrostatic discharge spacer;
g. a generally ring-shaped mounting bolt housing, abutting adjoining portions of said inner housing and said second electrostatic discharge spacer, having a spaced plurality of axial mounting bolt apertures axially and rotationally aligned with corresponding such mounting bolt apertures in said bulkhead and said second electrostatic discharge spacer;
h. a generally ring-shaped screw housing, abutting adjoining portions of said outer housing and said first electrostatic discharge spacer, having a spaced plurality of screw apertures axially and rotationally aligned with corresponding such screw apertures in said first electrostatic discharge spacer and a disc-shaped portion of said inner housing;
i. a plurality of screws, each screw extending through one of said screw apertures and corresponding screw apertures for secured engagement with a corresponding one of a plurality of screw retention inserts located in corresponding screw apertures in said inner housing disc-shaped portion;
j. a first tubular adaptor, coaxial with and sealingly attached to an inlet portion of said tubular outer housing; and
k. a generally cup-shaped insulator boot having a peripheral portion thereof attached at least to said mounting bolt housing, and an annular outer end face covering said mounting bolt and screw housings.

50. The bulkhead-type dielectric fitting of claim 49, further including a second tubular adaptor, coaxial with and sealingly attached to an outlet portion of said tubular inner housing.

51. The bulkhead-type dielectric fitting of claim 49, further including first and second anti-rotation mechanisms that serve to transmit torques, occurring during the installation of said fitting, back to said bulkhead.

52. The bulkhead-type dielectric fitting of claim 51, wherein said first and second anti-rotation mechanisms respectively include a first set of intermeshing, matching, teeth on said outer housing and said screw housing and a second set of intermeshing, matched, teeth on said inner housing and said mounting bolt housing.

53. A bulkhead-type dielectric fitting, extending through an aperture in the bulkhead of a vessel, for dissipating the electrical energy from static charges and controlling large current flows, caused by at least in part by fluid movements and the indirect effects of lightning, in case of such an occurrence, as well as providing safe passage of high pressure fluids therethrough, said fitting comprising in combination:
a. a stepped, generally tubular, inner housing;
b. a stepped, generally tubular, outer housing, coaxial with said inner housing;
c. a stepped, generally tubular spacer sealingly interposed between as well as both axially and radially separating said inner and outer housings;
d. a stepped, generally disc-shaped, first electrostatic discharge spacer interposed between as well as both axially and radially separating at least said inner and outer housings;
e. a stepped, generally disc-shaped second electrostatic discharge spacer sealingly interposed between said inner housing and an adjoining side of said bulkhead;
f. a stepped, generally tubular insulator housing, affixed to said inner housing, enveloping a cylindrical portion of said inner housing and abutting an annular end portion of said second electrostatic discharge spacer;
g. a generally ring-shaped mounting bolt housing, abutting adjoining portions of said inner housing and said second electrostatic discharge spacer, having a spaced plurality of axial mounting bolt apertures axially and rotationally aligned with corresponding such apertures in said second electrostatic discharge spacer;
h. a generally ring-shaped screw housing, abutting adjoining portions of said outer housing and said first electrostatic discharge spacer, having a spaced plurality of screw apertures axially and rotationally aligned with corresponding such screw apertures in said first electrostatic discharge spacer and a disc-shaped portion of said inner housing;
i. a plurality of screws, each screw extending through one of said screw apertures and corresponding screw apertures for secured engagement with a corresponding one of a plurality of screw retention inserts located in corresponding screw apertures in said inner housing disc-shaped portion;
j. at least one tubular adaptor, coaxial with and sealingly attached to at least one of an inlet portion of said outer housing and an outlet portion of said inner housing; and
k. a generally cup-shaped insulator boot having a peripheral portion attached at least to one of said screw and mounting bolt housings.

54. The bulkhead-type dielectric fitting of claim 53, further including a ring washer having a plurality of apertures, corresponding with said screw apertures, interposed between said plurality of screws and an adjoining side of said screw housing.

55. The bulkhead-type dielectric fitting of claim 54, wherein said insulator boot further includes an outwardly flared portion surrounding at least said adaptor.

56. The bulkhead-type dielectric fitting of claim 53, wherein said insulator boot further includes an annular outer end face covering the outer end faces of said mounting bolt and screw housings.

57. An in-line type dielectric tubular fitting for dissipating the electrical energy from static charges and controlling large current flows caused by at least in part by fluid movements and the indirect effects of lightning, in case of such an occurrence, as well as providing a safe passage of high pressure fluid therethrough, said fitting comprising in combination:
a. a stepped, generally tubular outer housing having a first large diameter inside surface portion separated from a first small diameter inside surface portion by a first annular step surface;
b. a stepped, generally tubular inner housing, defining a central cavity, having a second large diameter inside surface portion separated from a second small diameter inside surface portion by a second annular step surface, said second large diameter inside surface portion including an outside surface portion, with a predetermined axial section thereof extending into and being fixedly secured to said outer housing first large diameter inside surface portion, with said second large diameter inside surface portion together with said first and second small diameter inside surface portions defining a stepped central through bore including said central cavity and opposed first and second small diameter cylindrical end surface portions;
c. a first, generally tubular, stepped adaptor having a first inner annular end surface and adjoining spaced first inner and outer radial flange portions, located within said inner housing central cavity, as well as having a first axially outwardly directed small diameter tubular portion extending axially outwardly through said outer housing first small diameter inside surface portion;
d. a second, generally tubular, stepped adaptor having a second inner annular end surface and adjoining spaced second inner and outer radial flange portions, also located within said inner housing central cavity, as well as having a second axially outwardly directed small diameter tubular portion extending axially outwardly through said inner housing second small diameter inside surface portion;
e. a generally tubular center dielectric insulator located within said central cavity and sealingly radially interposed between said central cavity and said inner and outer first and second flange portions of each of said first and second adaptors, said center dielectric insulator also including a radially inwardly-directed center flange portions interposed between said first and second inner annular end surfaces of said first and second adaptors;
f. a first, generally tubular, stepped, end dielectric insulator, located in one end of said inner housing stepped bore, having a first inner end portion abutting an adjoining end portion of said center dielectric insulator, having a first outer end portion interposed between said outer housing first small diameter inside surface portion and a cylindrical portion of said first adaptor small diameter tubular portion, and having a first intermediate annular portion joining said first inner and outer end portions; and
g. a second, generally tubular, stepped, end dielectric insulator, located in another end of said stepped bore, having a second inner end portion abutting another adjoining end portion of said center dielectric insulator, having a second outer end portion interposed between said inner housing second small diameter inside surface portion and a cylindrical portion of said second adaptor small diameter tubular portion, and having a second intermediate annular portion joining said second inner and outer end portions.

58. The in-line type dielectric tubular fitting of claim 57, further including, in each of first and second axial recesses between said first and second inner and outer radial flange portions of said first and second adaptors, respectively, of a central, annular, seal member and a pair of adjoining, opposed, backup rings.

59. The in-line type dielectric tubular fitting of claim 58, wherein said seal member takes the form of an O-ring, comprised of an ethylene propylene type material composition and said pair of backup rings is comprised of a PTFE type material composition.

60. The in-line type dielectric tubular fitting of claim 57, wherein said inner and outer housings, as well as said first and second adaptors, are each comprised of a titanium alloy material.

61. The in-line type dielectric tubular fitting of claim 57, wherein said center dielectric insulator as well as said first and second end dielectric insulators each are comprised of ULTEM® 2300 material.

62. The in-line type dielectric fitting of claim 57, wherein said outer housing further includes a radially outwardly-directed further flange portion and said inner housing includes a still further radially outwardly-directed flange portion, with the addition of said further and still further flange portions modifying the construction of said in-line type dielectric fitting to that of a bulkhead-type dielectric fitting which extends through an aperture in the bulkhead of a vessel.

63. The bulkhead-type dielectric fitting of claim 62, further including, in each of first and second axial recesses between said first and second inner and outer radial flange portions of said first and second adaptors, respectively, the addition of a central, annular, seal member and a pair of adjoining, opposed, backup rings.

64. The bulkhead-type dielectric fitting of claim 63, wherein said seal member takes the form of an O-ring, comprised of an ethylene propylene type material composition and said pair of backup rings is comprised of a PTFE type material composition.

65. The bulkhead-type dielectric fitting of claim 62, wherein said inner and outer housings, as well as said first and second adaptors, each are comprised of a titanium alloy material.

66. The bulkhead-type dielectric fitting of claim 62, wherein said center dielectric insulator as well as said first and second dielectric insulators each are comprised of ULTEM® 2300 material.

67. One of an in-line and bulkhead type dielectric, generally tubular, fitting, for dissipating the electrical energy from static charges and controlling large current flows, caused at least in part by fluid movements and the indirect effects of lightning, in case of such an occurrence, as well as providing safe passage of high pressure fluids therethrough, said fitting including:
a. at least one stepped, generally tubular metallic first housing;
b. at least one stepped, generally tubular second metallic housing, coaxial with said first housing;
c. a stepped, generally tubular first spacer sealingly interposed between as well as both axially and radially separating said at least ones of said first and second housings;
d. at least one stepped, generally disc-shaped first electrostatic discharge spacer, interposed between as well as both axially and radially separating said at least ones of said first and second housings; and
e. at least one stepped, generally tubular insulator housing, enveloping at least a portion of one of said at least one of said first and second housings.

68. The dielectric fitting of claim 67, further including:
a. a third generally tubular metallic housing, coaxial with said first and second housings; and
b. a stepped, generally tubular second spacer sealingly interposed between at least two of said first, second and third housings, and both axially and radially separating at least two of said first, second and third housings, said fitting being one of an in-line type and a bulkhead type fitting.

69. The dielectric fitting of claim 68, wherein said first electrostatic discharge spacer is comprised of a Krefine, EKH-SS07 material composition.

70. The dielectric fitting of claim 69, wherein the electrical resistance between two of said first, second and third housings is controlled via said first electrostatic discharge spacer.

71. The dielectric fitting of claim 70, wherein the path of said electrical resistance proceeds axially outwardly from said first housing to one of said second and third housings via said interposed first electrostatic discharge spacer and vise versa.

72. The bulkhead type dielectric fitting of claim 67, wherein said generally tubular first housing further includes an axial extension member on one end thereof, said extension member including a hub portion and a coaxial generally disc-shaped portion, located intermediate said extension member and said one end of said first housing.

73. The bulkhead type dielectric fitting of claim 72, further including an insulator member having a central tubular hub, coaxial with said extension member, and a ring portion having a first annular end surface abutting a corresponding annular end surface of said disc-shaped portion of said extension member, with the addition of said disc-shaped portion and said insulator member modifying the construction of said in-line dielectric fitting to that of a bulkhead type fitting adapted to at least partially extend through an aperture in the bulkhead of a vessel.

74. The bulkhead type dielectric fitting of claim 73, wherein said one end of said tubular first housing includes, at said extension member, a peripheral controlled weak portion.

75. The in-line dielectric fitting of claim 68, wherein said tubular first spacer provides a minimum of at least 3.81 cm. of electrical insulating space from said first and third housings.

76. The in-line dielectric fitting of claim 68, wherein said insulator housing provides a predetermined first minimum of at least 7.62 cm. of linear insulating distance and a second minimum of at least a 2.54 cm. line-of-sight distance insulating space.

77. The dielectric fitting of claim 67, wherein said fitting being a bulkhead-type fitting, extending through an aperture in the bulkhead of a vessel, said fitting further including:
a. stepped, generally disc-shaped second electrostatic discharge spacer, sealingly interposed between said first housing and an adjoining side of said bulkhead;
b. a generally ring-shaped mounting bolt housing, abutting adjoining portions of said first housing and said second electrostatic discharge spacer, having a spaced plurality of axial mounting bolt apertures axially and rotationally aligned with corresponding such apertures in said second electrostatic discharge spacer;
c. a generally ring-shaped screw housing, abutting adjoining portions of said second housing and said first electrostatic discharge spacer, having a plurality of screw apertures axially and rotationally aligned with corresponding such screw apertures in said first electrostatic discharge spacer and a disc-shaped portion of said first housing;
d. a plurality of screws, each screw extending through one of said screw apertures and corresponding screw apertures for secured engagement with a corresponding one of a plurality of screw retention inserts located in said corresponding screw apertures in said first housing disc-shaped portion;
e. at least one tubular adaptor, coaxial with and sealingly attached to at least one of an inlet portion of said second housing and an outlet portion of said first housing; and
f. a generally cup-shaped insulator boot having a peripheral portion attached at least to one of said screw and mounting bolt housings.

78. The bulkhead-type dielectric fitting of claim 77, further including a ring washer having a plurality of spaced apertures, corresponding with said screw apertures, interposed between said plurality of screws and an adjoining side of said screw housing.

79. The bulkhead-type dielectric fitting of claim 77, wherein said first and second electrostatic discharge spacers are comprised of a Krefine material composition.

80. The bulkhead-type dielectric fitting of claim 77, wherein said first housing includes an axially extending outlet portion, on one end thereof, said outlet portion having, at a predetermined axial distance from said bulkhead, a peripheral controlled weak portion, with a first fracture plane passing through said controlled weak portion, thereby providing a controlled first breakaway feature.

81. The bulkhead-type dielectric fitting of claim 77, wherein the control of said electrical resistance, between said second and first housings, is controlled via said first and second electrostatic discharge spacers.

82. The bulkhead-type dielectric fitting of claim 81, wherein the path of said controlled electrical resistance proceeds from said bulkhead, via said second electrostatic discharge spacer, to said first housing and, via said first electrostatic discharge spacer, to said second housing, and from said first housing, through said first electrostatic discharge spacer, to said second housing and vice versa.

83. The bulkhead-type dielectric fitting of claim 77, wherein said screws are frangible screws, with said fitting further including a second fracture plane essentially passing through the threaded portion of said frangible screws, adjoining said locking screw inserts, thereby providing a controlled second breakaway feature.

84. The bulkhead-type dielectric fitting of claim 77, wherein said tubular spacer provides a minimum of at least 3.81 cm. of electrical insulating space, on the inner side of said bulkhead, that electrically isolates said first housing from said second housing.

85. The bulkhead-type dielectric fitting of claim 77, wherein said insulator boot provides a first surface length of at least 7.62 cm. of linear insulating space and a second line-of-sight insulating distance of at least 2.54 cm., on the outer side of said bulkhead, that prevent the portion of said fitting, on the outside of the bulkhead, from creating an electrical path.

86. An in-line type dielectric tubular fitting for dissipating the electrical energy from static charges, caused at least in part by fluid movements and the indirect effects of lightning, in case of such an occurrence, as well as providing a safe passage of fluids therethrough, said fitting comprising in combination:
a. a pair of coaxial, oppositely-directed, stepped, tubular inner housings;
b. a pair of coaxial, oppositely-directed, stepped, tubular outer housings, with a first one of said pair of outer housings being coaxial with and peripherally surrounding a first one of said pair of inner housings, with a second one of said pair of outer housings being coaxial with and surrounding a second one of said pair inner housings, said second one of said pair of outer housings including an axially further extending intermediate portion, with said intermediate portion being peripherally surrounded by said first one of said pair of outer housings and securing same against relative rotation therebetween;
c. a stepped, generally tubular, first spacer sealingly interposed between as well as both axially and radially separating said pair of inner housings;
d. a pair of coaxial, oppositely-directed, stepped, generally tubular second spacers, with a first one of said pair of second spacers being interposed between said first one of said pair of inner housings and said intermediate portion for both axially and radially separating said first one of said pair of inner housings and said intermediate portion, with a second one of said pair of second spacers being interposed between said second one of said pair of inner housings and said second one of said pair of outer housings for both axially and radially separating said second one of said pair of inner housings and said second one of said pair of outer housings;
e. a pair of coaxial, oppositely-directed, stepped, generally cylindrical electrostatic discharge spacers, with a first one of said pair of electrostatic discharge spacers being interposed between and separating said first one of pair of inner housings from at least said first one of said pair of outer housings and, with a second one of said pair of electrostatic discharge spacers being interposed between and separating said second one of said pair of inner housings from at least said second one of said pair of outer housings; and
f. a pair of coaxial, oppositely-directed, generally cup-shaped insulator housings, with a first one of said pair of insulator housings enveloping at least a single one of said first ones of said pairs of inner and outer housings and, a second one of said pair of insulator housings enveloping at least a single one of said second ones of said pairs of inner and outer housings.

87. The in-line type dielectric tubular fitting of claim 86, further including, at about the junction of said second one of said pair of outer housings with said further axially extending intermediate portion thereof, a radially outwardly directed flange portion, with said flange portion including at least one axially directed through aperture.
